(19) United States
(12) Patent Application Publication
(10) Pub. No.: US 2006/0111874 A1
(43) Pub. Date: May 25, 2006

(54) Method and system for filtering, organizing and presenting selected information technology information as a function of business dimensions

(75) Inventors: Gayle Curtis, Palo Alto, CA (US); Christopher O. Burnley, Daly City, CA (US); Humphrey N. Williams, Palo Alto, CA (US)

Correspondence Address: RAYMOND R. MOSER JR., ESQ.;MOSER IP LAW GROUP, 1040 BROAD STREET, 2ND FLOOR, SHREWSBURY, NJ, 07702, US

(73) Assignee: Blazant, Inx.

(21) Appl. No.: 11/042,579

(22) Filed: Jan. 24, 2005

Related U.S. Application Data
(60) Provisional application No. 60/614,649, filed on Sep. 30, 2004.

(51) Int. Cl. G06F 11/30

(52) U.S. Cl. 702/186; 705/8; 705/28

(57) ABSTRACT

A method and system for filtering, organizing and presenting selected information technology (IT) information as a function of business dimensions, through guided analysis, are disclosed. The method and system may be based on the needs and role of the viewer requesting such IT asset information at the time of the request.

### CROSS REFERENCE TO RELATED APPLICATIONS

This application claims the benefit of U.S. provisional patent application Ser. No. 60/614,649, filed Sep. 30, 2004, the entire content of which is herein incorporated by reference.

### BACKGROUND OF THE INVENTION

1. Field of the Invention

Embodiments of the present invention generally relate to filtering, organizing and presenting selected information technology (IT) asset information as a function of business dimensions to an end user (i.e., viewer) or end user computer and, more particularly, to a method and system for filtering, organizing and presenting selected IT asset information as a function of business dimensions to an end user based on the needs and role of the viewer requesting such IT asset information at the time of the request.

2. Description of the Related Art

Most complex business decisions are made after obtaining and analyzing all relevant information regarding a particular business problem or issue. To make a successful decision, one needs access to all pertinent information. Managing, retrieving and presenting large amounts of data in a business or other organization to provide information to the decision maker are daunting tasks. These matters are complicated when people, at different levels of an organization, taking on different roles that change at different times, are involved in the decision making process and request specific types of information.

Organizations may use server-based computer networks to store, manage, access and provide such information to the end user or viewer. These networks are commonly managed by IT specialists. A typical computer network generally comprises a plurality of interconnected user computers, which in turn are connected to at least one computer server via a data communications network. The server commonly includes memory storage devices for storing information as well as operating system (OS) and application software. Through information management software and other means, the stored information is accessible by end users or viewer at a given user computer.

However, such information is not generally organized or readily accessible to the then current viewer. Instead the viewer is forced to review extensive amounts of potentially irrelevant data in making a particular business decision at any given time. Typically, the vast majority of data management tools available are designed to allow systems administrators to maintain computer networks but not to provide selected IT asset information to resolve real time business issues and make informed IT asset related business decisions.

Oftentimes, there is an entire IT infrastructure within an organization's infrastructure. As such, IT professionals may not know, for example, each and every hardware or software application an organization is using and whether it is properly licensed, or what expensive applications the organization has licensed and is not fully using, or which computers and peripherals are being used and what those computers are being used for, and the like.

An initial step in the process of taking inventory of IT assets to respond to the aforementioned IT related business type questions is to collect and store all of the aforementioned IT asset information. Gathering, storing and managing IT asset information is made possible by technology available from Blazent, Inc. of San Mateo, Calif. Examples of methods and apparatus are described in commonly assigned U.S. Pat. No. 6,782,350, entitled “Method and Apparatus for Managing Resources,” the entire disclosure of which is incorporated by reference herein. Generally, a software package is installed on network servers, client computers and/or other IT devices where IT asset information is desired and obtained from substantially each and every IT device and peripheral, owned or being used by the organization.

For example, the aforementioned Blazent technology takes inventory of IT computers, provides utilization information, and the like. It then gathers this information into a data storage device or data warehouse. The technology is capable of providing information regarding IT assets and the utilization of these IT assets. Each person at different times, and with potentially different roles, would need to look at different IT asset information.

Even if the correct IT asset or resource information exists, it is often incompatible and dispersed throughout the organization or in multiple reports, making the information difficult and cumbersome to manage and use. Furthermore, IT professionals, at different times, and with potentially different needs in the organization, may want to receive only information necessary to make a decision at that time for a particular business issue and not receive other information available to other IT professionals at different times with different needs. This makes it difficult to resolve complex business issues involving IT assets.

Therefore, there is a need for a method and system for filtering, organizing and presenting IT asset information as a function of coupled business dimensions and IT related business issues based upon current needs at a particular time to assist in making an informed IT related business decision or resolution for the organization in context with a business dimension.

### SUMMARY OF THE INVENTION

Embodiments of the present invention relate to a method and system for identifying IT assets affected by a business issue condition. The method and system comprise determining an appropriate business dimension of assessment, and measuring (assessing) the condition of the IT assets along that predetermined business dimension, and presenting the result so the degree of the business issue condition can be directly presented and understood by the requester.

Embodiments of the method and system further include linking the report(s) or presentation(s) of the result(s) into a guided analysis of the affected IT assets along other business dimensions pertinent to the business resolution.

An embodiment of the present invention comprises a method and system for identifying and presenting IT assets information to a viewer based upon selected business dimensions so the viewer can see the IT asset related business issues in context and make continuous temporal changes in a decision path as additional IT asset information is presented to the viewer. This coupling of the IT asset information and business dimensions, while providing specific decision metrics, allows a user to resolve complex IT related business issues in a unique and innovative manner.

In another embodiment, there is provided a method and system for visualizing an IT related business issue, accessing from stored memory IT asset data connected to business dimensions, analyzing the IT asset data based upon at least one predetermined criterion, sorting the IT asset data in accordance with the viewer's current role, which relates to the predetermined criterion, and presenting to the viewer or end user computer the sorted IT asset data to assist in making an informed business decision.

Embodiments of the method and system further comprise using the resulting initially sorted IT asset data as a guide for additional requests. This iterative process can be repeated as many times as necessary until the viewer receives the IT asset information needed to make an informed IT related business decision.

Alternatively, each viewer can make more than one request for IT asset information. The request(s) can range from high level IT asset information to detailed, low level IT asset information. The requests can also relate to various temporal roles of the viewer at the time of the request(s).

In another embodiment of the present invention, there is provided a method for filtering, organizing and presenting a selection of IT asset information to an end user, comprising providing IT asset information stored in a searchable database; receiving search criteria from the end user computer based upon a visualization of a business problem or goal and a predetermined initial scenario; analyzing IT asset information, using business specific guided analysis, embedded in Structured Query Language (SQL) statements from the database in accordance with the search criteria; sorting and retrieving a subset of IT asset information based upon the results of the guided analysis of the IT asset information; and providing the subset of IT asset information to the end user computer. Alternatively, the subset of IT asset information can be provided to the end user or viewer.

The subset of IT asset information provided to the end user computer or end user can be a function of the issue presented and the business dimension(s) used to resolve the issue. The subset of IT asset information provided to the end user computer can be displayed on a display device in accordance with the requests from the viewer.

By way of a specific example, the subset of IT asset information provided can be in response to a request using a given scenario requested by a chief information officer (CIO). The subset of IT asset information would include high level views concerning, for example, how many licenses have been paid and how many more need to be paid. The subset of IT asset information provided in response to a second scenario can be for an IT director (analyst) who needs to know the budgetary impact on the IT budget of paying for those licenses mentioned above. Furthermore, the subset of IT asset information provided can be in response to a request by an IT implementer, who needs to know which computers actually need a license. It should be noted that, although this approach to solving an IT asset related business issue is through a set of scenarios, there is no limit to the number or type of scenarios available to each user.

Alternatively, the request(s) can be made by the same viewer at any given time during a session. Each resulting subset of IT asset information can alternatively include additional IT asset information for retrieval and review by a user.

In another embodiment, the above hierarchical data structure can be used to obtain IT asset information relating to server usage, upgrade needs, resource allocation, memory availability, and the like.

### BRIEF DESCRIPTION OF THE DRAWINGS

So that the manner in which the above recited features of the embodiments of the present invention can be understood in detail, a more particular description of embodiments of the present invention, briefly summarized above, may be had by reference to embodiments, some of which are illustrated in the appended drawings. It is to be noted, however, that the appended drawings illustrate only typical embodiments of the present invention and are therefore not to be considered limiting of its scope, for the present invention may admit to other equally effective embodiments, wherein:

FIG. 1 is a block diagram of a computer network system in accordance with an embodiment of the present invention;

FIG. 2 is a block diagram of a computer network system in accordance with another embodiment of the present invention, detailing a report generator;

FIG. 3 is a bar chart depicting the results of an initial analysis of a breakdown of IT assets as partitioned by a suitably chosen business dimension in accordance with an embodiment of the present invention;

FIG. 4 is a functional block diagram detailing the data warehouse and report generator of FIG. 2, including scenario hierarchical structure and business dimensions;

FIG. 5 is a flow diagram of a method of analyzing, filtering, sorting and displaying a subset of IT asset information as a function of the scenarios and business dimensions shown in FIG. 4;

FIGS. 6A-6M depict example screen displays of an IT asset information gathering session and data display of IT asset information reports in accordance with an embodiment of the present invention; and

FIGS. 7A to 7R depict charts of analytics and scenario overviews of selected IT asset information used to populate certain of the reports depicted in FIGS. 6A-6M.

While embodiments of the present invention are described herein by way of example using several illustrative drawings, those skilled in the art will recognize the present invention is not limited to the embodiments or drawings described. It should be understood the drawings and the detailed description thereto are not intended to limit the present invention to the particular form disclosed, but on the contrary, the present invention is to cover all modification, equivalents and alternatives falling within the spirit and scope the present invention as defined by the appended claims.

The headings used herein are for organizational purposes only and are not meant to be used to limit the scope of the description or the claims. As used throughout this application, the word “can” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

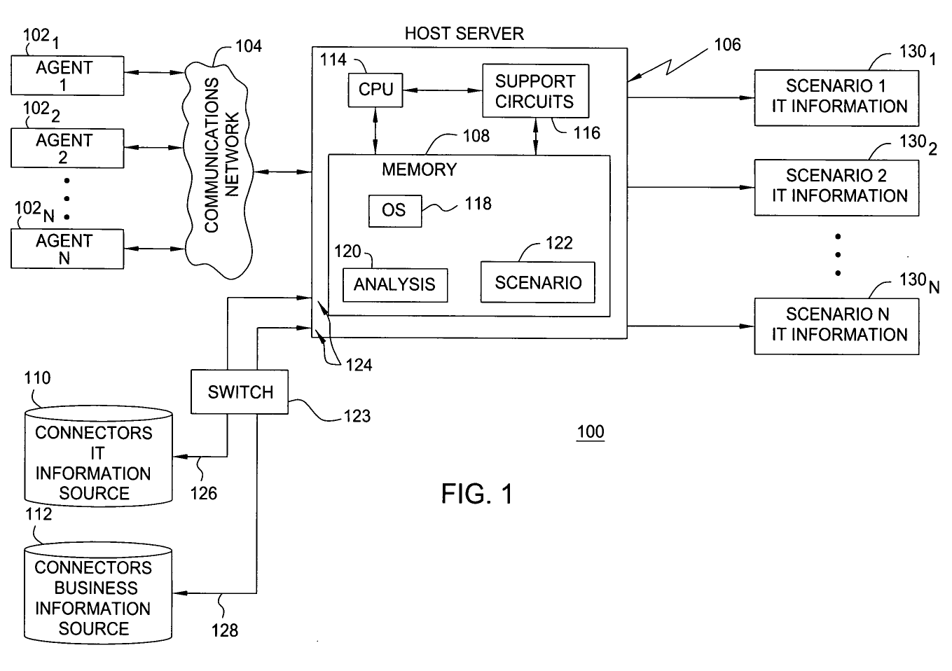

FIG. 1 depicts a computer network 100 in which embodiments of the present invention may be utilized. The computer network 100 portrays one variation of the myriad of possible network configurations capable of processing information in accordance with embodiments of the present invention. For example, FIG. 1 could have depicted numerous host servers 106 as well as a plurality of memory storage volumes 108. For simplicity and clarity, one host server 106 and one memory storage volume 108 are depicted and described below. Embodiments of the present invention, as shall be discussed below, include a method and system for filtering, gathering and presenting selected IT asset information to a viewer, end user, or an end user computer that incorporates a computer network as that shown in FIG. 1 and herein described.

The computer network 100 comprises a plurality of client computers or agents 102₁, 102₂ . . . 102ₙ. The agents are connected to one another through a conventional data communications network 104. The host server 106 is coupled to the communication network 104 to receive requests from the viewer, supply application and data services, such as selected IT asset information, as well as supply other resource services to the agents 102₁, 102₂ . . . 102ₙ. An IT asset information source database 110 and a business information source database 112 are connected to the host server 106 via a conventional network data switch 123 for use by the host server 106 to couple certain business dimensions with IT asset information in accordance with an embodiment of the present invention. The host server 106 is also coupled to display units to provide subset IT asset information to displays 130₁, 130₂ . . . 130ₙ for the user to view. These displays may be configured in accordance with predetermined scenarios 1, 2 . . . n that were provided by a user through any one of agents 102₁, 102₂ . . . 102ₙ.

The host server 106 comprises at least one central processing unit (CPU) 114, support circuits 116, and internal memory 108. The CPU 114 may comprise one or more conventionally available microprocessors. The support circuits 116 are well known circuits used to promote functionality of the CPU 114. Such circuits include but are not limited to a cache, power supplies, clock circuits, input/output (I/O) circuits, and the like.

The memory 108 contained within the host server 106 may comprise random access memory (RAM), read only memory (ROM), removable disk memory, flash memory, and various other types or combinations of these types of memory. The memory 108 is sometimes referred to main memory and may, in part, be used as cache memory or buffer memory. The memory 108 generally stores the operating system (OS) software 118 of the host server 106 and various forms of application software.

In one embodiment, analysis software 120 and scenario software 122 are shown as application software. Scenario software 122 may also be referred to herein as guided analysis software, and visa versa. In addition, the use of the terms “scenario” and “guided analysis” are interchangeable. The software is a tool for assisting the user in resolving the given business issue or issues through a guided approach. The OS software 118 may be one of a number of commercially available operating systems such as, but not limited to, SOLARIS from SUN MICROSYSTEMS, INC., AIX from IBM INC., HP-UX from HEWLETT PACKARD CORPORATION, LINUX from RED HAT SOFTWARE, WINDOWS 2000 or later versions from MICROSOFT CORPORATION, and the like.

The conventional network data switch 123 couples the input/output (I/O) ports 124 of the host server 106 to the I/O ports 126 and 128 of the source databases 110 and 112. The source databases 110 and 112 generally comprise one or more disk drives, or disk drive arrays, that are used as mass storage devices for the host server 106. The databases 110 and 112 may include SQL or other relational databases.

As previously mentioned, the process of collecting, storing and managing IT asset information from all resources in an organization can be implemented by hardware and software as described in U.S. Pat. No. 6,782,350, the entire disclosure of which is incorporated by reference herein. From that or a similar system, one can collect and store the desired IT asset information. It should be noted other computer systems can also adequately gather this sort of IT asset information to populate such databases. No matter how the information is gathered and stored, embodiments of the present invention, as described herein, access the databases to create subsets of IT asset information as functions of appropriate business dimensions.

The scenarios 122 they may be generated, in part, by using a question and answer format in accordance with an embodiment of the present invention. Specifically, the exact language used in the dialog between the user and the system can have an effect on the outcome of human-computer interaction—just as it can in the dialog between individuals. It is largely through language—in the labels and instructions provided—that individuals can communicate what actions and IT asset information the user needs and what kind of response the user can expect from the host server 106.

Scenarios 130₁, 130₂ . . . 130ₙ may also be generated analyzing the breakdown in IT assets into subsets of IT asset information, where the breakdown is a result of coupling a particular business dimension with the requested IT asset information. The scenarios may also be referred to as “problem space viewers”, where such items change as the viewer is migrating through the system in an attempt to solve IT asset related business issue.

In one embodiment for generating and displaying subsets of IT asset information based on predetermined scenarios used in connection with the computer network described in FIG. 1, the following is an example of sequences describing the human-computer interaction dialog for creating the predefined scenarios. The bold titles identify the example steps in the interaction sequence for each scenario and, where possible, the actual name of a report. The italicized text represents the on-screen descriptive text that sets up each report prompt. An HTML page having an outline with descriptive and instructive text for each scenario is also provided. The sequences maintain context and outline a workflow for reaching the scenario goal. From this, individual reports can be created.

[image]

[image]

Server Consolidation - Functional

```
1. Identify Target Server Requirements
    Research the baseline platform, capacity and networking requirements for the target Functional
    server (e.g., Mail, DB).
2. Survey the Current Server Landscape (recommended, though optional)
    A. See the whole Server landscape
    Run the report “Server Roles and Functions” to have an overview of server deployments and to
    get a quick reading on the number of servers that may be candidates for further screening.
    B. Identify Potential Candidates for Functional Consolidation
    Drill to “Hardware Summary” for the selected Function to see department, location, and platform
    information for the servers with the selected Function. Sort by platform, location to get a sense
    of potential problems or opportunities.
3. Specify Target Server Configuration
    Specify the minimum configuration for a server deployed in the selected function. This
    information will be used to identify a set of servers that are candidates for consolidation.
    Target Function
    Select the target Function for the consolidated servers. This prompt requires at least one
    selection.
    Target Role
    Select the target Role for the consolidated servers[‘Any’ is default]
    Target Machine Manufacturer
    Select the target Machine Manufacturer for the consolidated servers[‘Any’ is default]
    Target OS
    Select the target Operating System for the consolidated servers[‘Any’ is default]
    Target CPU
    Select the target CPU speed for the consolidated servers[‘Any’ is default]
    Target RAM
    Select the target memory capacity for the consolidated servers[‘Any’ is default]
    Target Free Disk Space
    Select the target available Disk Capacity for the consolidated servers[‘Any’ is default]
    Target Free Processor Time
    Select the target available Processor Time for the consolidated servers[‘Any’ is default]
    Target Free Memory Utilization
    Select the target average Memory Utilization for the consolidated servers[‘Any’ is default]
    Target Network I/O Rating
    Select the target Network I/O Rating for the consolidated servers[‘Any’ is default]
    Target Departments
    Select the Departments to be considered for the consolidated servers[‘Any’ is default]
    Target Locations
    Select the Locations to be considered for the consolidated servers[‘Any’ is default]
4. Identify Consolidation Candidates
    Run the report
```

The above description is merely one embodiment of generating scenarios contemplated by, and within the scope of, the present invention. Other means for generating scenarios are herein described. Also, scenarios may be combined with other data such as business dimensions, hereinafter described.

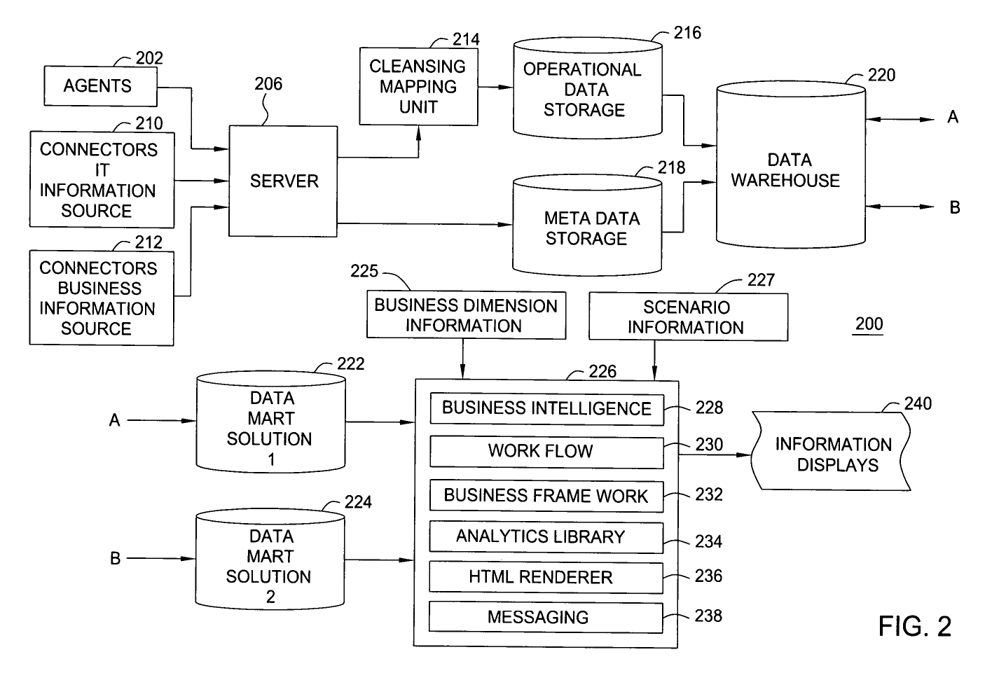

FIG. 2 is a block diagram of a computer network in accordance with another embodiment of the present invention, including a detailed schematic of a report generator 226, which may or may not include business dimension information and scenarios generated as discussed above. This embodiment provides a means for generating iterative reports based upon input relating to certain business issues and corresponding business dimensions as a function of the business issues presented.

Similar to FIG. 1, this computer server network 200 includes one or more agents 202, a host server 206, an IT asset information source 210, and a business information source 212. Also depicted in this computer server network 200 are a cleansing mapping unit 214, operational data storage 216 and meta data storage 218. The operational data storage 216 and the meta data storage 218 send and retrieve information to the data warehouse 220.

The data warehouse 220 is coupled to two separate databases, which correspond to separate solutions and relate to business issue requests results. Specifically, data mart solution 1 database 222 relates to one solution and data mart solution 2 database 224 relates to a second solution. These subsets of information are coupled to a report generator 226. Business dimension information 225 and scenario information 227 can be iteratively fed into the report generator 226 to assist in selecting and retrieving the appropriate IT asset information needed to resolve the outstanding business issue of the current query.

The report generator 226 comprises report generating interactive databases including, but not limited to, a business intelligence database 228, a work flow database 230, a business framework database 232 and an analytics library database 234. The report generator also includes an HTML renderer 236 and messaging device 238 for creating the displayed reports of information. Such information is optionally displayed on IT information displays 240.

Thus, the computer server network disclosed in FIG. 2 is capable of providing a high level view of, for example, problems and opportunities available to IT managers, where such problems and opportunities manifest themselves through the use of assessing a business issue, by coupling a selected business dimension to IT asset information based upon the business issue sought to be resolved.

That is, in an embodiment of the present invention processed through the system shown in FIG. 2, there is provided a method for partitioning IT asset information as a function of a suitably chosen business dimension or several business dimensions. As a next step in the method, the IT asset information can be broken down into subsets. These subsets are then analyzed by the business dimension(s) so chosen in order to partition the retrieved data into groups.

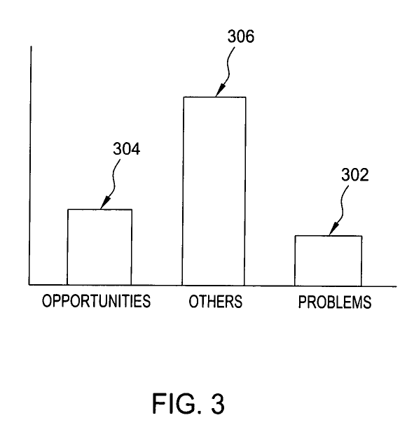

As best shown in FIG. 3, these groups of information, by way of example only, can be broken into “problems” 302, “opportunities” 304, and “others” 306. Each business scenario or issue has a different way of attaching the concepts “problem” or “opportunity” to an instance of the business dimension(s). The analytics provided may be calculated using business specific guided analysis embedded in SQL statements and report designs.

For any given business issue, the “problems” 302 manifested from the process can relate to the specific business issue in question and are generated by coupling an appropriate business dimension with the current IT related business issue. Similarly, the “opportunities” 304 that arise are related to the specific business issue in the same or similar way. Finally, the results that follow in the “others” category 306 relate to the specific business issues that arise in the same or similar way.

The bar graph shown in FIG. 3 can be referred to as an overview analytic. This overview analytic bar graph displays total counts of the number of “problems” 302 by problem type. It also displays total counts of the number of “opportunities” 304, for example, to save money. Finally, it displays total counts of the numbers of “others” 306 that do not fall in either category of “problems” 302 or “opportunities” 304 and therefore do not need to be addressed by the viewer at the given time. The “others” are considered to be effectively in the norm and will present neither an “opportunities” nor a “problem” to the requesting viewer of IT asset information, given the particular business issue at hand.

The overview analytics of FIG. 3 can show information in a single combined analytics or by use of a set of analytics. By showing this overview, a business issue, problem (or problems) can be put in the proper context. That is, where a business issue arises, it arises with respect to IT assets. The viewer can observe both “problems” and “opportunities” (and neither “problems” nor “opportunities,” i.e., “others”) in one display and be able to make a final decision or to continue searching for further IT asset information in order to make a final decision.

The computer server networks discussed above with respect to FIGS. 1 and 2 also provide a link for selecting a “problem” or an “opportunity” upon which to work. This allows the opening up of a detailed display of the “problem” or “opportunity” selected so the viewer can have continuity in his or her search for a solution to his or her IT related business issue.

As a result, a user is able to identify IT assets affected by a business problem condition by determining an appropriate dimension of assessment, measuring (or assessing) the condition of the IT asset along that business dimension. The viewer is presented with the results in such a way that the degree of the problem condition can be read directly. Then, the presentation is linked to a guided analysis of the affected assets along other business dimensions pertinent to the ultimate business solution. Thus, FIG. 3 depicts a graphical representation of the IT assets affected by a particular business issue.

One way of achieving the above guided analysis is by determining the critical business dimension or dimensions. In other words, determining a critical business dimension or several critical business dimensions throughout the course of the analysis will eventually identify the critical solution, during which the user will be guided to that solution. By way of a particular example, but in no way limiting in the scope of the present invention, given a particular problem, i.e., how many of a particular IT asset, i.e., software packages or PC's that need updating, and the like, are represented by the “problem” 302 graph. The “problem” graph 302 may reveal these particular IT assets are out of compliance or out of specification. The other end of the spectrum may consider how many are not in trouble but over specified and have excess capability. These assets are represented by the “opportunity” graph 304, i.e., these assets can be given additional workload. The remaining assets are represented by the “other” graph 306, i.e., these assets are neither “problems” nor “opportunities.”

An organization may have a need for high level decision making, which requires giving quick access to, for example, cost information tied to discovered inventory and utilization data. In accordance with embodiments of the present invention, a report can be generated that focuses on the alternative actions contemplated or implied in the business problem, e.g., desktop migration, license optimization, etc., and their cost and time ramifications.

One way that makes this possible is the manner the cost data is provided. Instead of requiring the customer to enter cost data before using it for estimating a table of standard values for costs, time estimates and system requirements are maintained. A table may be included with the system and then updated by periodic import into the data warehouse (see FIG. 2). The following is an example of a high level decision report that may occur during the initial analysis stage:

| | | What IT Resource Management Platform |
|---|---|---|
| | Key Questions | can provide |
| Survey | What is the scope of the problem? | Overview of the current state of problem |
| | What's going on that I don't know about | area |
| | now? | Visual representation of the problem |
| | What is a promising avenue of | landscape |
| | approach? Where to start looking for | Visibility into hidden or non-obvious |
| | solutions? | elements |
| Identify/ | Which assets are most relevant to the | Sorted, isolated lists of assets keyed on |
| Isolate | problem? (most involved, most critical) | specific attributes |
| | Which attributes of these assets are | Detailed information about relevant |
| | most salient to the problem; how do they | assets (drills) |
| | relate to each other & to the assets? | |
| Evaluate | Which factors are most important to the | Evaluation of selected assets for |
| | best solution? (cost, utilization, time, etc) | utilization rate, cost or other business |
| | Which assets might be employed in the | impact |
| | solution? | Exportable reports that can be used by |
| | | other stakeholders (e.g. finance) |
| Plan | What exactly do we need to do with/to | Detailed reports that can tie specific sets |
| | the assets to reach a solution? | of assets to specific actions or activities |
| Execute | How is the solution realized, in detail, | Detailed reports that specify assets to be |
| | step by step? | involved in the solution |
| | | Framework to support workflow |
| Monitor | How far have we moved toward | Overview of the current state of problem |
| | resolution of the problem? | area |
| | | Could be an iteration of the survey report |

| | |
|---|---|
| Current Business Problem Targets | Goals |
| Desktop Standardization/Migration | Visibility of assets, profile users |
| Server Consolidation | Reduce cost of more capacity |
| License Optimization | Eliminate waste, reduce risk |
| IT Cost Chargeback | Rationalize charges, recover more |
| | costs |
| Helpdesk Management | Quicker resolution of trouble calls |

In another embodiment, to connect the IT product functional requirements to the requirements of real business issues, these issues are characterized through solution scenarios. These scenarios are built on a common model describing the phases a user might go through to resolve the business issue. Each phase is characterized by a predominant goal or user intent, key questions that are indicative of that phase, and the information that reports can provide in support of that phase. The user can then use this model to understand and specify the report requirements for each scenario.

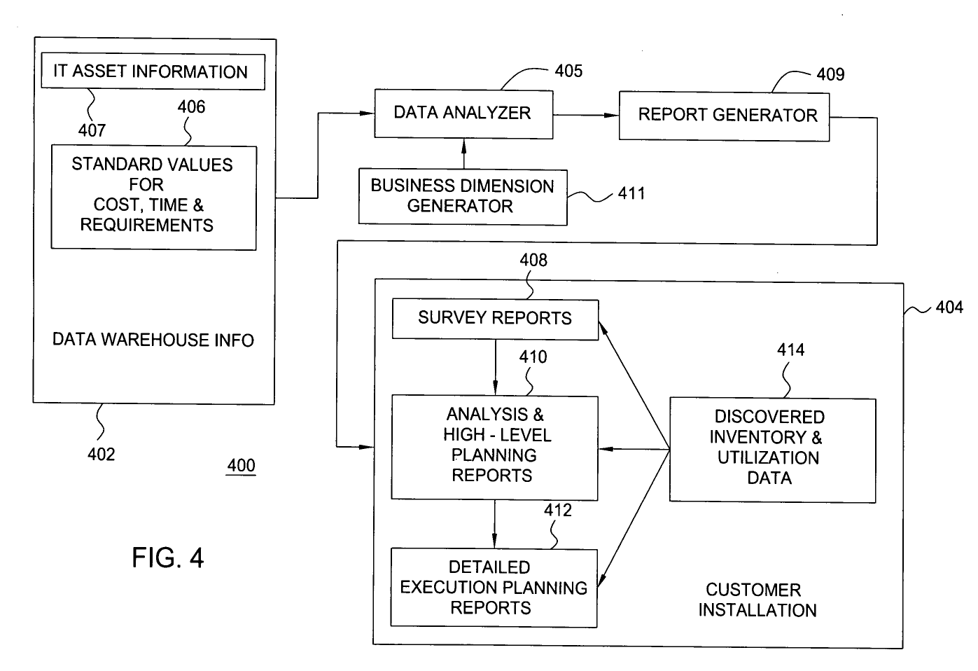

FIG. 4 depicts a functional block diagram 400 of such a process, including a detailed description of the report generator of FIG. 2, and the interaction of the aforementioned scenarios. FIG. 4 demonstrates, in part, the scenarios hierarchical structure and business dimensions in accordance with an embodiment of the present invention. This particular block diagram shows levels of reports available to solve an IT related business issue.

The diagram 400 is divided into two major functional groups. The first group is the data warehouse information database 402, which, in this embodiment, includes data relating to standard values for costs, time and requirements 406, and IT asset information 407. The second group is the customer installation 404. Information from the data warehouse information database 402 is coupled to the customer installation 404 via a data analyzer 405 and a report generator 409 as previously described. A business dimension generator 411 is operatively coupled to the data analyzer 405 to provide selected business dimensions for analyzing the IT related business issue.

The customer installation group 404 may comprise survey reports 408 operatively coupled to the guided analysis and high-level planning reports 410, which are operatively coupled to the detailed execution planning report 412. Additional data is operatively coupled to the aforementioned reports. As an example, discovered inventory and utilization data 414 is operatively coupled to the survey reports 408, guided analysis and high-level planning reports 410 and detailed execution planning reports 412, respectively. Such reporting and inquiring of information allows an IT professional to be able to solve a business issue or meet a business goal through the receiving of a subset of IT asset information stored in the data warehouse information database 402.

Thus, in accordance with embodiments of the present invention, the information is gathered, filtered and presented to the end user based on scenarios requested to provide the information necessary for making a business solution or business goal. As mentioned previously, there are an infinite number of scenarios or business dimensions that may interact with IT asset information in order to obtain the appropriate subset of IT asset information for a given user or user computer.

The above general discussion with respect to the functional block diagram of FIG. 4 may be applied to specific IT asset related business issues. In this regard, the following six examples demonstrate business issues, with Example 1, demonstrating a general procedure for resolving a business issue through the system depicted in FIG. 4. The remaining five examples relate to a business issue. However, it is to be understood that these examples utilize a similar general procedure as that depicted with respect to Example 1.

### EXAMPLE 1

### Software Standardization

The CIO leaves an executive committee meeting with a mandate to put the latest version of OUTLOOK on every computer in the company, because of various productivity gains from the new version, including integrated calendaring and enhanced meeting creation. She passes this mandate on to her Director.
The Director knows OUTLOOK needs at least WINDOWS 2000 to run, and he knows he will have to upgrade a number of computers.
He also sees an opportunity for cost savings by reducing the number of operating systems (OS's) the help desk has to support, not to mention the potential increase in user satisfaction that would come with a more powerful OS. He has wanted to standardize the company on WINDOWS 2000 for a long time and this is his chance!
He needs to get back to the CIO with cost and timeframe estimates.
As he starts thinking about the problem, the following questions come to mind:
   1. How many computers do I have that aren't already on WINDOWS 2000? [how big a problem is this?—absolute]
   2. What proportion is this of the total number of desktop computers running some version of WINDOWS? [how big a problem is this?—relative]
   3. What is the minimum hardware configuration needed to support WINDOWS 2000, given the computers also have to support a number of other applications in order to be useful where they are? [screen for upgrade candidates] How does this minimum configuration vary by department or job title? [maybe multiple screens for upgrade candidates]
   4. Of the computers not already on WINDOWS 2000, how many have hardware configurations that could support WINDOWS 2000 as well as do the other things they need to do? [apply screens to get the upgrade candidates]
   5. What will it take to do the OS upgrades? [time and cost estimates] Is there a different cost depending on the existing installed OS, e.g., WINDOWS95 vs. WINDOWS98? [maybe multiple time and cost estimates]
   6. Of those that have insufficient hardware capability, what would it take to get them up to the minimum configuration for the role they're in? [potential upgrade candidates] What would these hardware upgrades take? [time and cost estimates]

When he works through these questions and comes to reasonable answers, he will need to make an implementation plan, and this raises other questions:
1. Where are the candidate computers? [location and department]
2. How does the distribution of IT support resources match up with the distribution of upgrade candidates? [Is there IT staff where it is needed?]
3. Specifically, which user computers can be assigned to which IT staff to implement the upgrade? [user-level assignment]

The following is an example sequence to be performed in two stages. The first stage is a quick response. The second stage is a verification and refinement of the quick response:

Stage 1:
How many people?
Where are they located?
How many computers attached to persons?
Of these computers, how many are PC's/UNIX workstations/other?
   One could stop here and the CIO would have enough information to discuss the impact but not cost. If cost is vital, then the next two steps should be taken:
Decide on an average cost if 60% had to be upgraded, 10% had to be replaced and all of the UNIX and Other needed a PC, which leaves 30% untouched?
Calculate the cost of licenses for all of the computers (use retail prices)?

Stage 2:

Further refine the data by:
Showing the information by location and department. Determining the actual computers that need to be upgraded/replaced—OS, then RAM
Determine strategy for non-PC users
Do a first pass negotiation for licensing costs
Do a first pass at the support staff impact—this means looking at the locations and determining if people will have to travel, determine how many can be done per day and still maintain services levels. Get a quick bid from an outside source to come in and perform software upgrades.
This will give a very good estimate of the overall project impact and costs.
Stage 3 and beyond are the planning and negotiation stages that eventually determine the strategy (in or out sourcing) and replacement, upgrade, license fees which should be less (if the IT resource management platform has complete and accurate information) than originally anticipated because no negotiation had really occurred.
   Discovery
To begin, the Director runs the Computer Upgrade Analysis report to find out how many computers have the hardware capability (processor speed, memory, disk space) to support the upgrade.
He also wants to know where these upgrade candidate computers are, both their location and department, so he can make a specific plan—where to start and how to proceed. This is shown in the basic report.
In addition, he looks at those that could be OS upgrade candidates if they had a simple hardware upgrade. If it is just a matter of more memory, that is an easy way to bring another computer up to the standard OS configuration. This may be shown in a separate, optional report.
   Guided Analysis and Planning
Looking at the Computer Upgrade Analysis report, he sees there are a number of computers with WINDOWS 95/98. He also sees that most of them are in the HR department.
He drafts a plan to phase in the upgrades by location and by department, and to begin with HR.
He knows by experience that the time needed to upgrade the OS is longer if the existing OS is a much older version, so he runs a report that shows just the OS distribution within the candidate computers and exports that to an Excel file.
Using Excel he fills in the cost and time data for each type of upgrade and does the projections. When this report is complete, he writes up a summary and sends it on to the CIO.
He runs a report showing location, department and user name for the candidate computers and also exports it to Excel. He hands off this Excel file to appropriate department managers who will create specific task assignments for the IT staff. The tech's will know exactly which computers they need to upgrade, both software and hardware if applicable, and what is installed there already.
   Execution and Monitoring
He is almost finished with his plan. He runs one more report that shows the proportion of upgrade candidate computers to those that are on WINDOWS 2000. Right now, this one gives him a snapshot of the initial starting point for the upgrade project—how far he is away from the target.
He sets up a subscription to this report with a weekly update frequency. With this setting, he will only need to check his IT resource management list to see how many computers have been upgraded each week. This report will be based on actual data reported from each computer, and it will give him an accurate measure of progress toward his goal.
He sets up a subscription to the same report for the CIO, with settings to show the overview graphic first. When he sends his regular status reports up to the CIO, he reminds her that she can check the project status directly using the IT resource management platform and the History List it provides.

### EXAMPLE 2

### License Compliance

A high level IT professional may need certain information to make an informed business decision about inventory or licensing compliance. Such IT professional may want to include in a report the number of computers, laptops and dedicated servers capable of running the newest OS software that the organization is considering purchasing in the near future. The next level IT professional may need to drill down and request information relating to how many of those computers, laptops and servers in the organization are being used and by whom. The next IT professional may need information on location of equipment, condition, licensing compliance, and the like. Each individual will want to see only that information needed to make his or her business decision at that particular time.

The company has purchased many licenses for an expensive software package. Is the company getting its money's worth? Are the licenses being well used or even used at all?
An IT resource management report is run showing numbers of licenses, numbers installed, and numbers used. A graph tells the story: A first bar shows the number of licenses purchased. A second smaller bar shows numbers installed and a third even smaller bar shows numbers actually used.
The user looks at the delta between purchased and installed and sees an opportunity for immediate cost savings if the company returns or does not renew those licenses. At minimum, the user can defer purchasing more licenses and reduce the annual maintenance payment for only the licenses being used.
The user looks at the delta between the installed and used and sees an opportunity to increase productivity if the company increases utilization through training or removing other obstacles to usage, or reduces cost by not renewing the licenses. If the user decides to proceed with low utilization, the company should also see reduced maintenance costs.

### EXAMPLE 3

### Hardware Consolidation

Company is contemplating a merger, physical consolidation of IT hardware, or downsizing. In each of these scenarios there is the prospect of excess or underutilized hardware in the outcome. How can the company make sound projections about what it will have, what it will need and where it should go in the company's final hardware inventory?
The user runs a series of IT resource management reports to learn about computers and locations, hardware configurations, vendors and OS's. From this discovered data, the user makes a plan for consolidation that moves assets to the places where they will be most valuable in the resulting organization.
The user also identifies excess hardware inventory that could be sold or applied to new initiatives.

### EXAMPLE 4

### Disaster Recovery Planning (Business Continuity Planning)

With the perspective of 9/11 in mind, the company sees the prudence of having a plan in place for business continuity should the unthinkable happen at any one of its offices or locations.
IT resource management reports are run that show detailed views of hardware and software inventory. These reports are analyzed to show ranking of actual usage for hardware and software, by location and department.
What are the most critical applications, the hardware that is needed to support them, and the most active locations and departments? Based on company judgment, thresholds are set for each of these, and a plan is formed.
As a result, the company has a high level of confidence about what it would need to buy or replenish to get up and running in the shortest possible time following a severe interruption.

### EXAMPLE 5

### Vendor Stratification

The company deals with a lot of hardware and software vendors. When it looks at the number of software titles and the predominance of a relative few number of vendors there, the company sees an opportunity to negotiate volume pricing on some of these.
But how does the company know how much it actually has from MICROSOFT, MACROMEDIA, or ADOBE? Does procurement know how much is spent on applications? Not really.
The user runs an IT resource management report that ranks manufacturers by number of installs. Looking at the grid data, the user sees opportunities to focus on the handful of vendors at the top. It would be worth negotiating a better deal with these vendors.
The vendors at the bottom of the list have smaller numbers not worth locking us into a deal, especially in areas where things are changing fast.

### EXAMPLE 6

### Budgeting and Planning

How can the company plan for what it will need five years out? Where should it be building resources—and vendor alliances?
The user runs an IT resource management report that lets the company see the compound average growth rate for usage of an application such as EXCEL. Analyzing the trend of usage growth, the company has something on which to base projections and to form a plan.

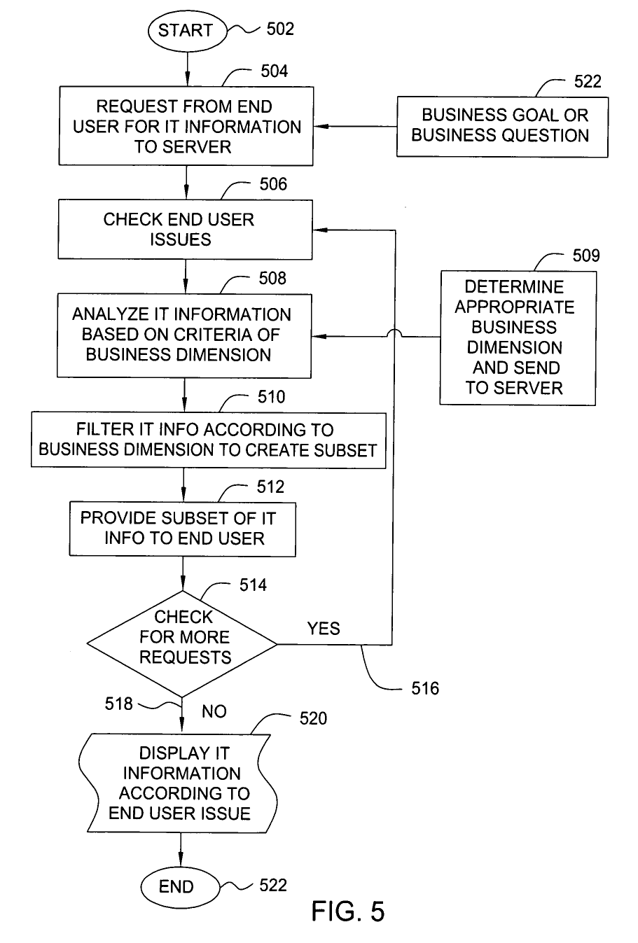

FIG. 5 depicts a flow diagram 500 detailing a method of resolving business issues similar to the previously discussed six scenarios in accordance with an embodiment of the present invention. Detailed procedures of the guided analysis of IT asset data and how that data is filtered, organized and presented to the end user are provided. In one embodiment, such information is displayed on the end user computer. Once the business issue or goal is determined, the process begins at step 502. The method is intended to display information related to a particular business decision. Next, the server 106 receives a request from the end user 504 for a subset of IT asset information. At step 506, the server checks the end user issue related to a business decision that is to be made and compares the issue to the scenario application 122 in memory 108 of the host server 106.

Once the given issue is identified, a set of criteria is sent to the host server 106. The host server, using this set of criteria, accesses the IT asset information source 110 via the network switch 123 through I/O ports 124 and 126. At about the same time, the host server 106, via the I/O port 124 and 128, interfaces with the business information source. At step 508, the host server 106 analyzes the IT asset information through guided analysis software 120 based on the criteria of a selected business dimension, which has been determined by the business dimension source 509. The server then sorts that information necessary to respond to the user. At step 510, that information is filtered into a subset of IT asset information and is received by the host server 106. At step 512, such information is presented to the end user.

This information is displayed, for example, at Scenario 1, IT asset information 130₁. At step 514, the server 106 checks for more requests from the same or additional users. If there are additional requests, the server follows step 516 and returns to checking the particular type of scenario in order to analyze the IT asset information accordingly. If, on the other hand, no further requests are made, the host server will follow step 518 and display the subset of IT asset information according to the given end user business issue at step 520. The process will then end at step 522 until another request is made.

Although it has been described that one business issue is being resolved at one time, it is within the scope of embodiments of the present invention to have multiple requests made at a given time by either the same user or multiple users on the network 100 as shown in FIG. 1 and the network 200 as shown in FIG. 2.

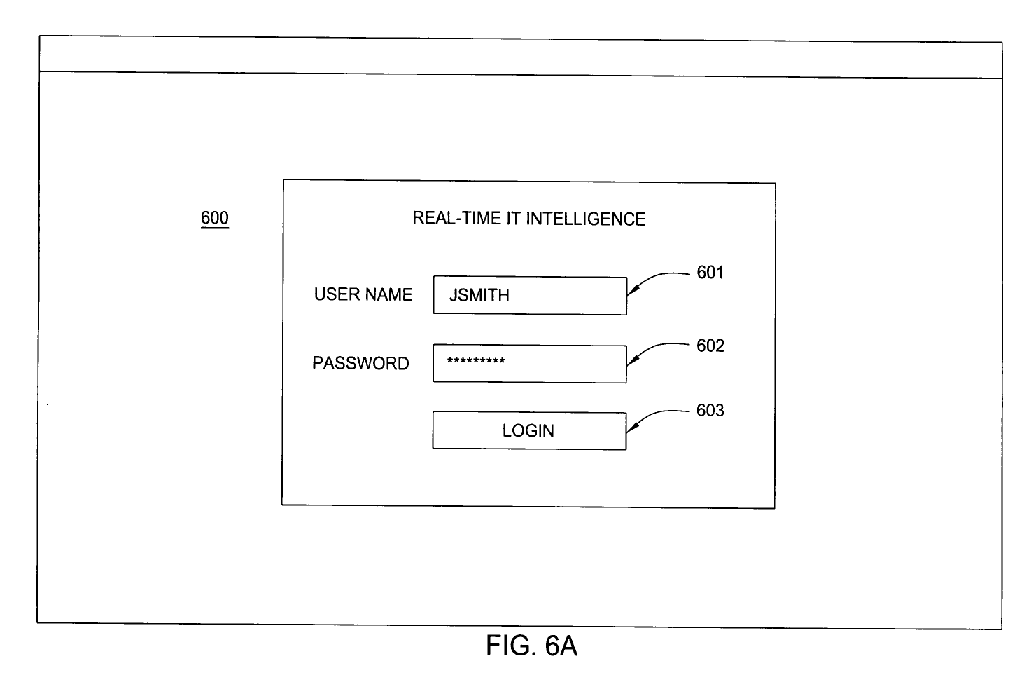

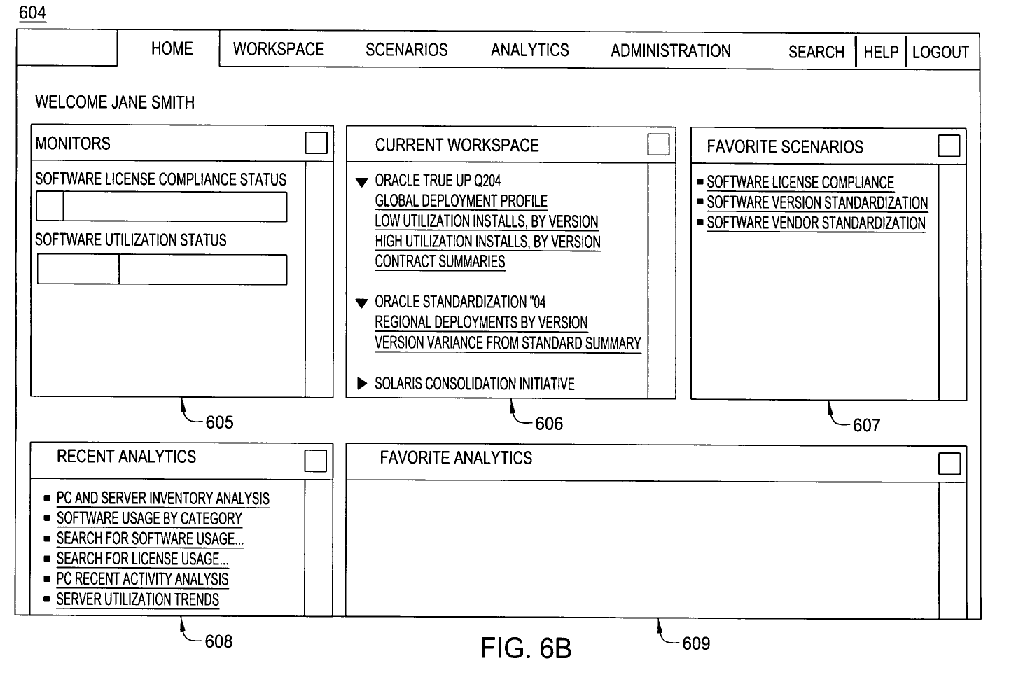

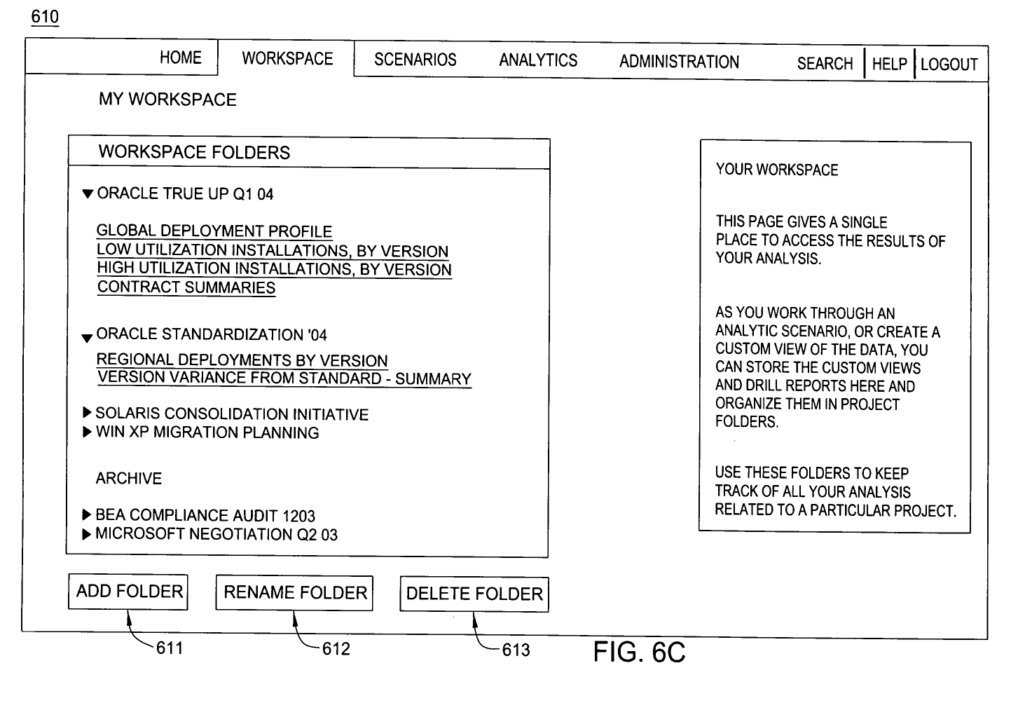

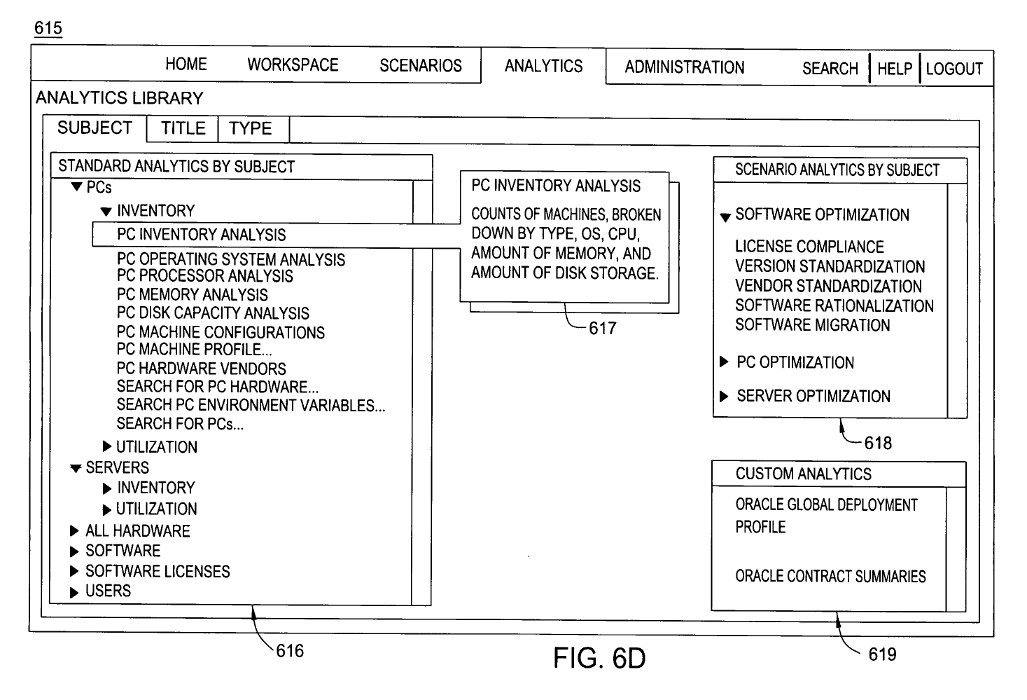

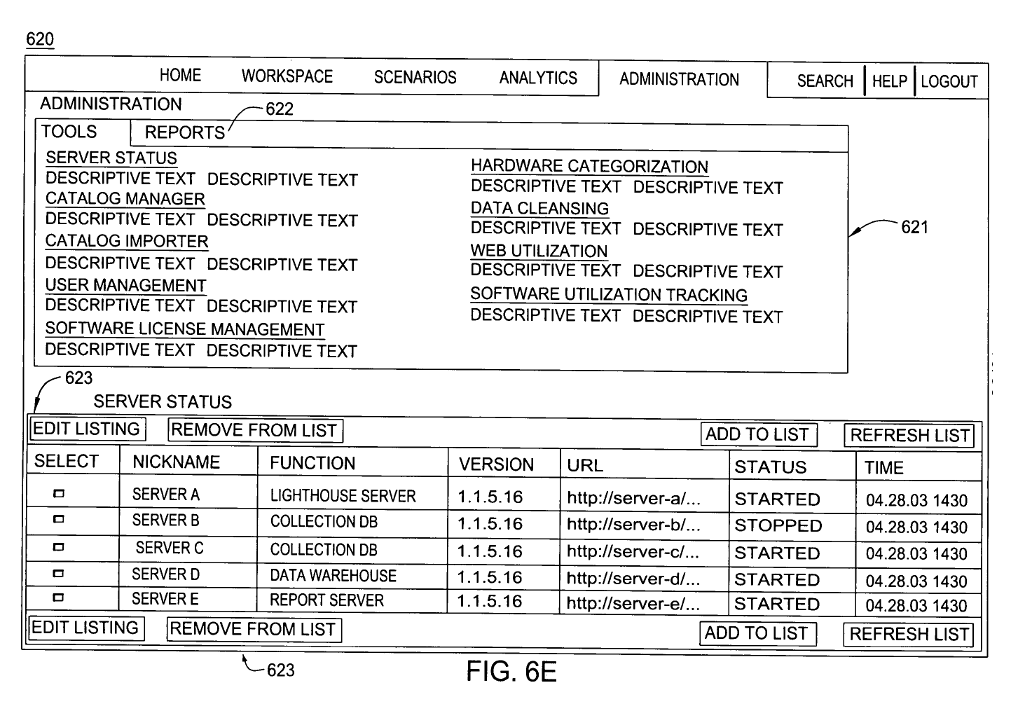

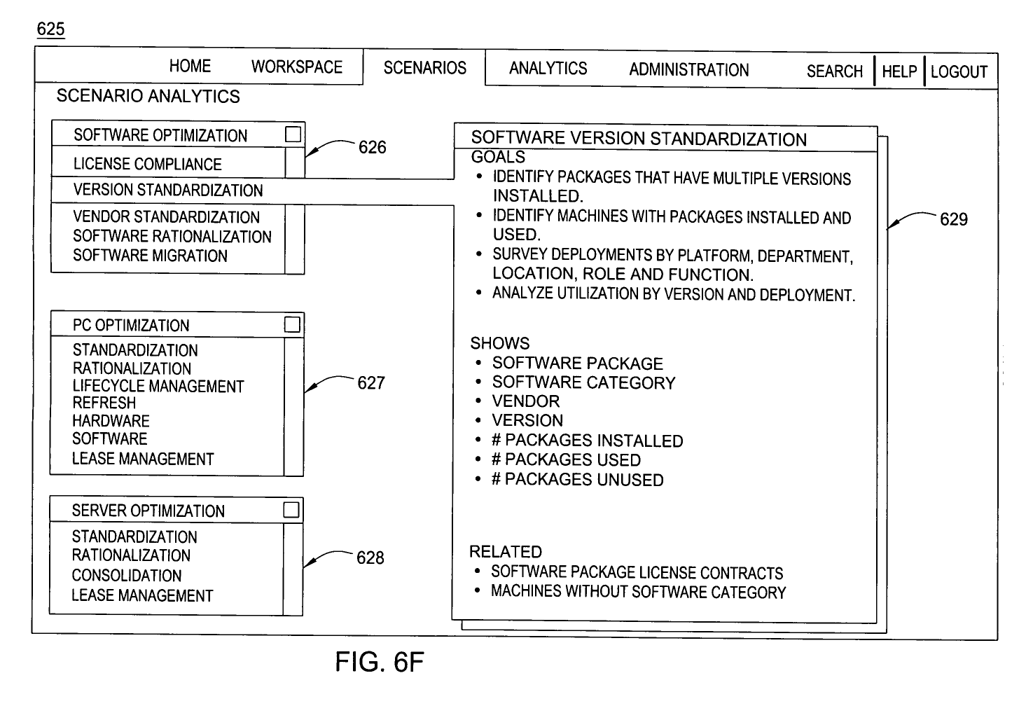

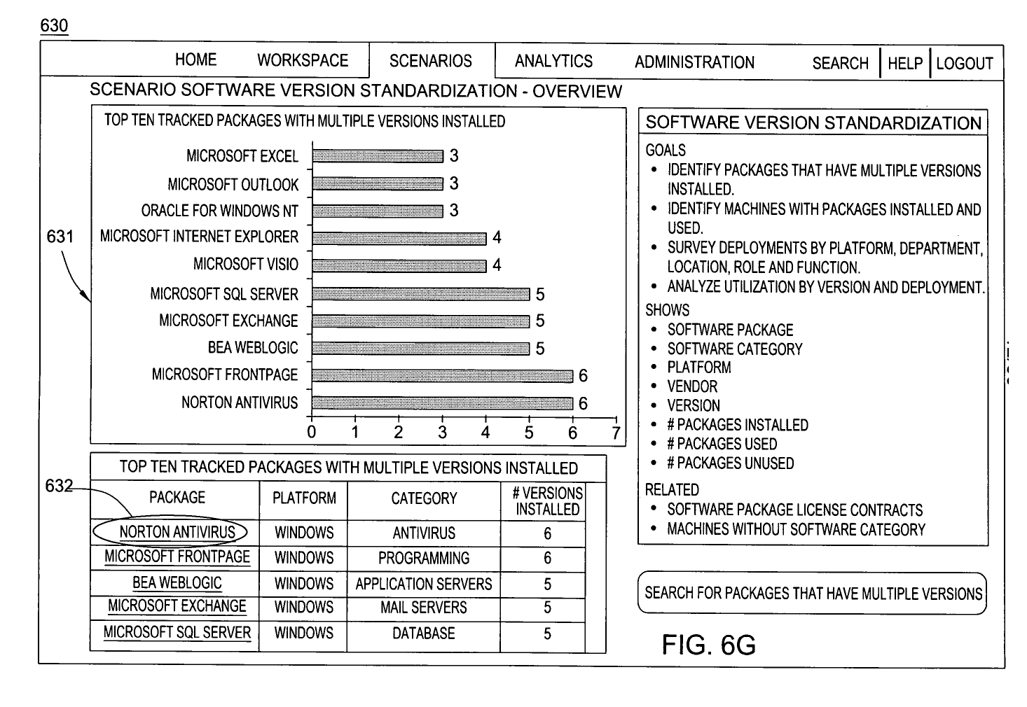

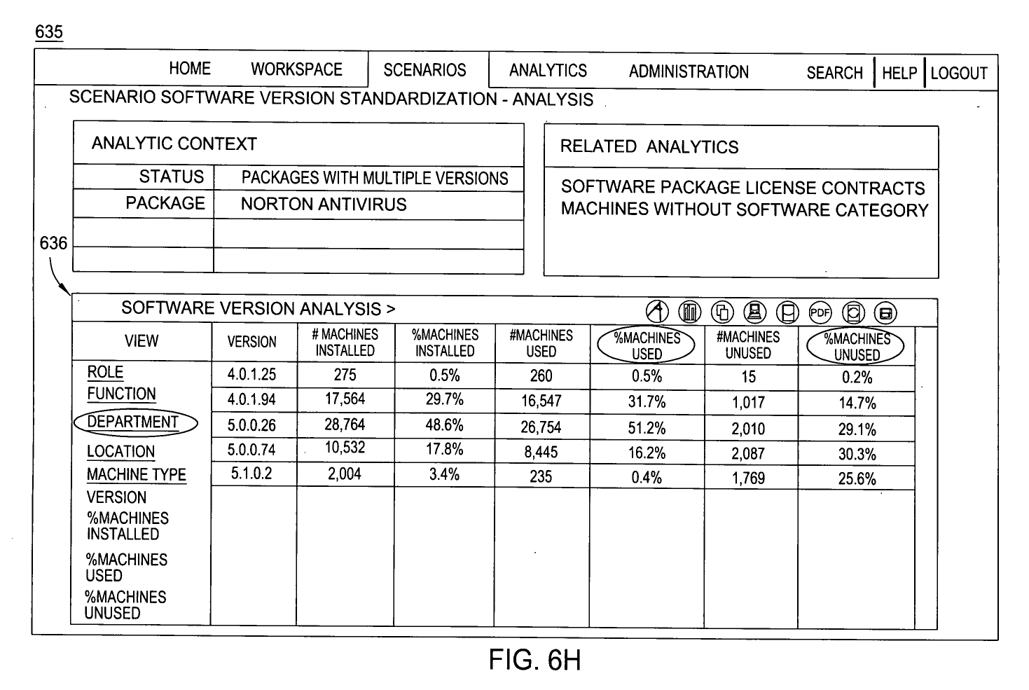

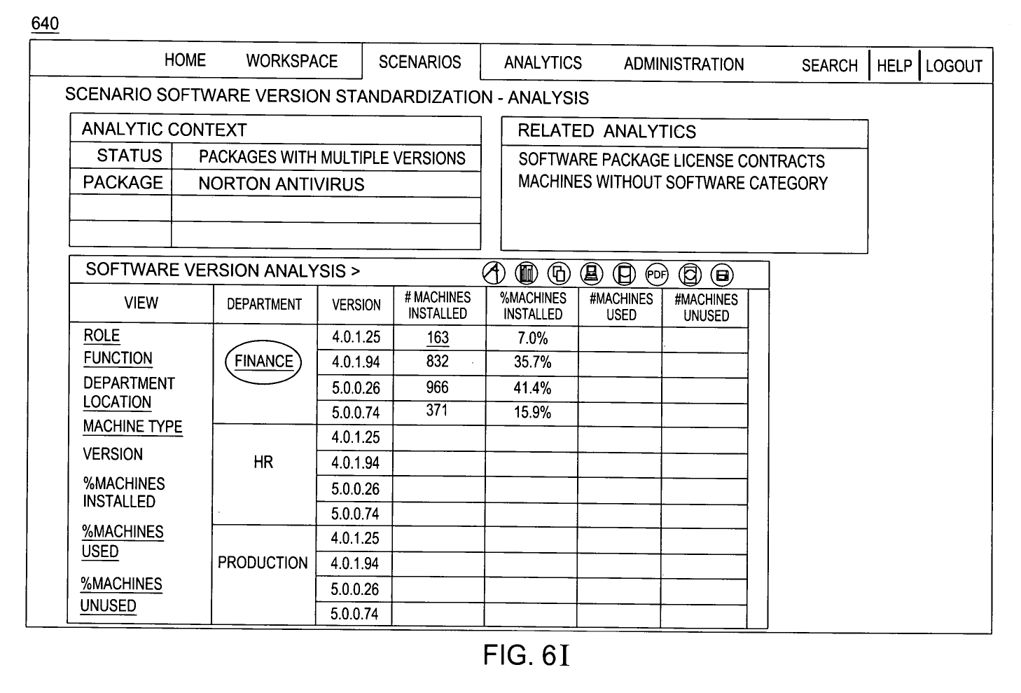

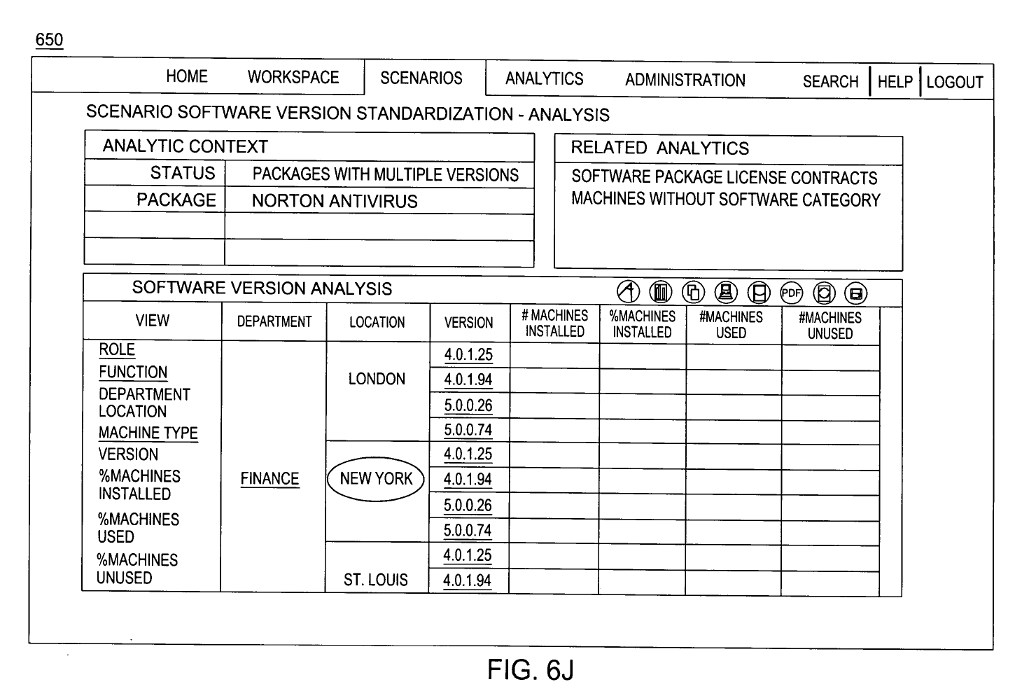

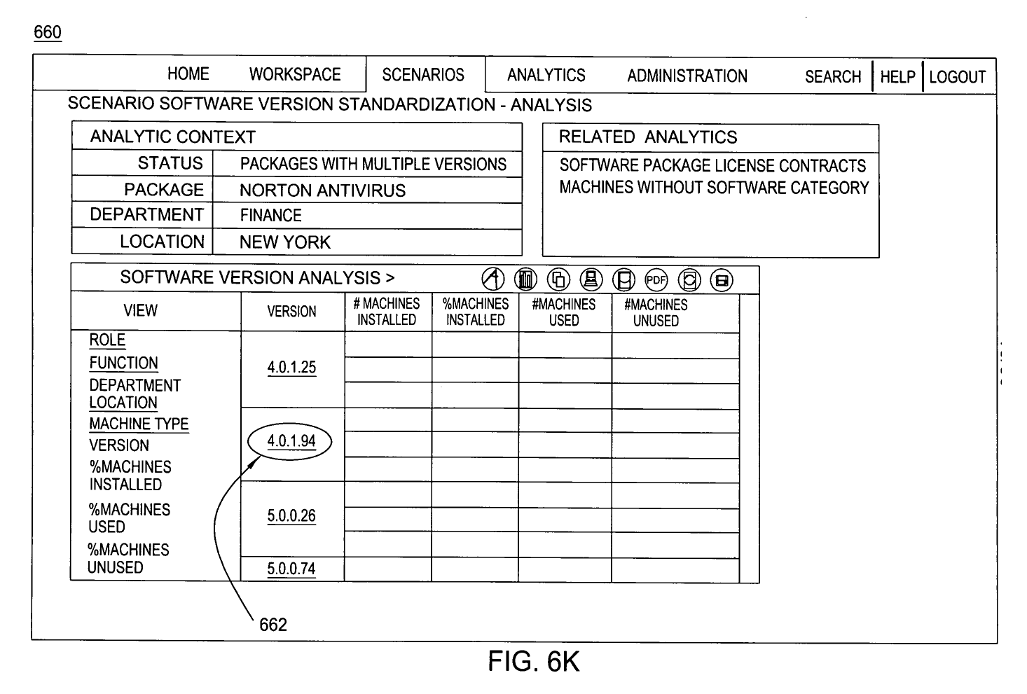

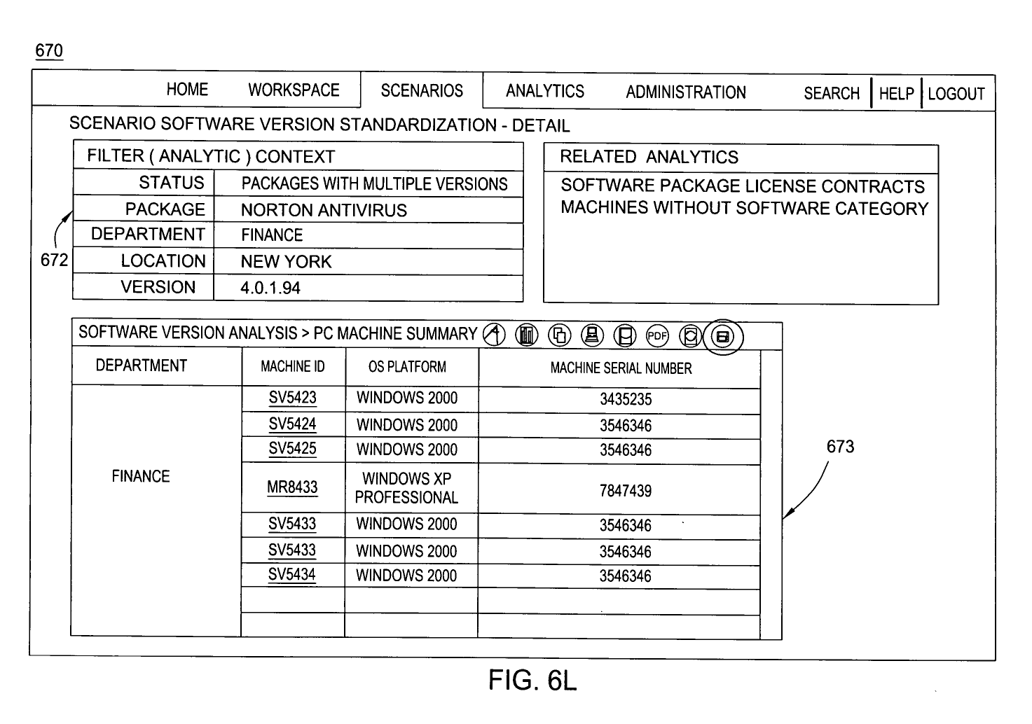

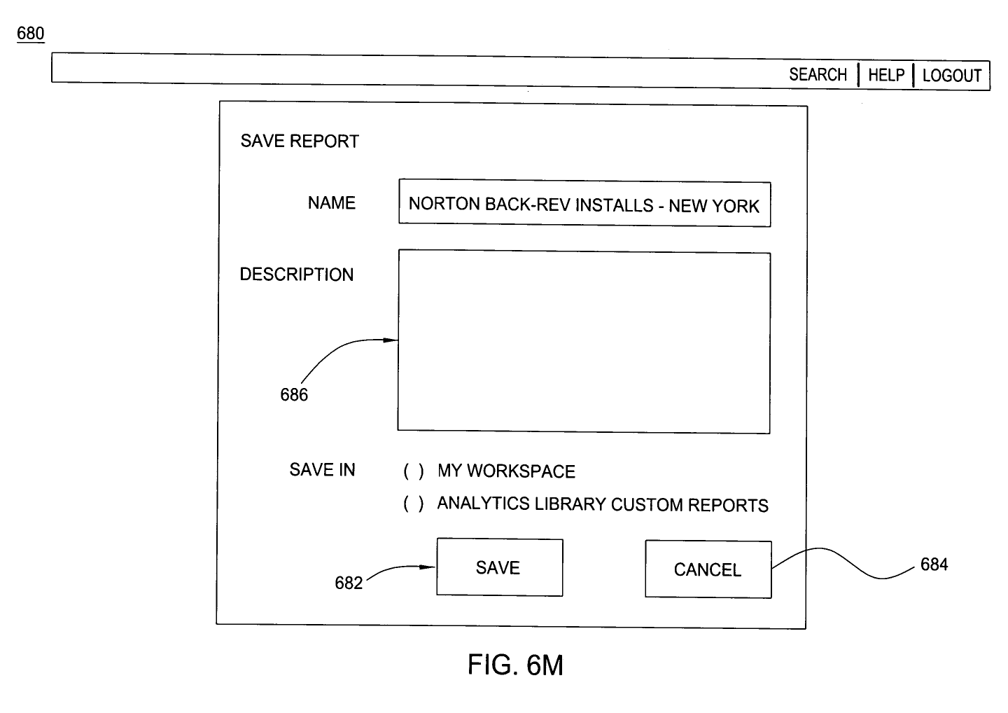

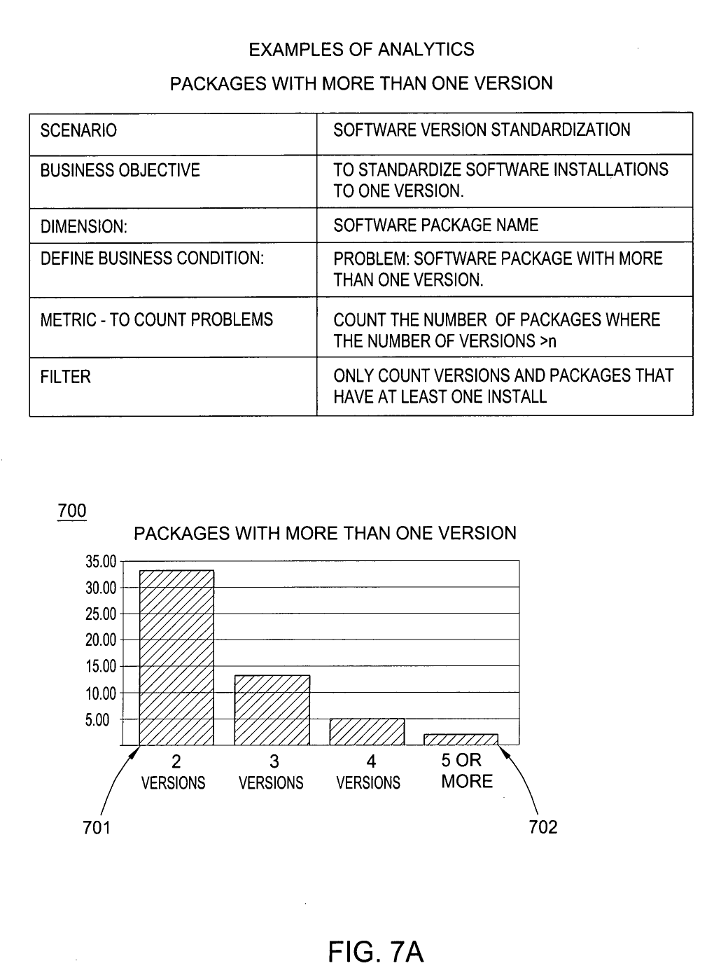

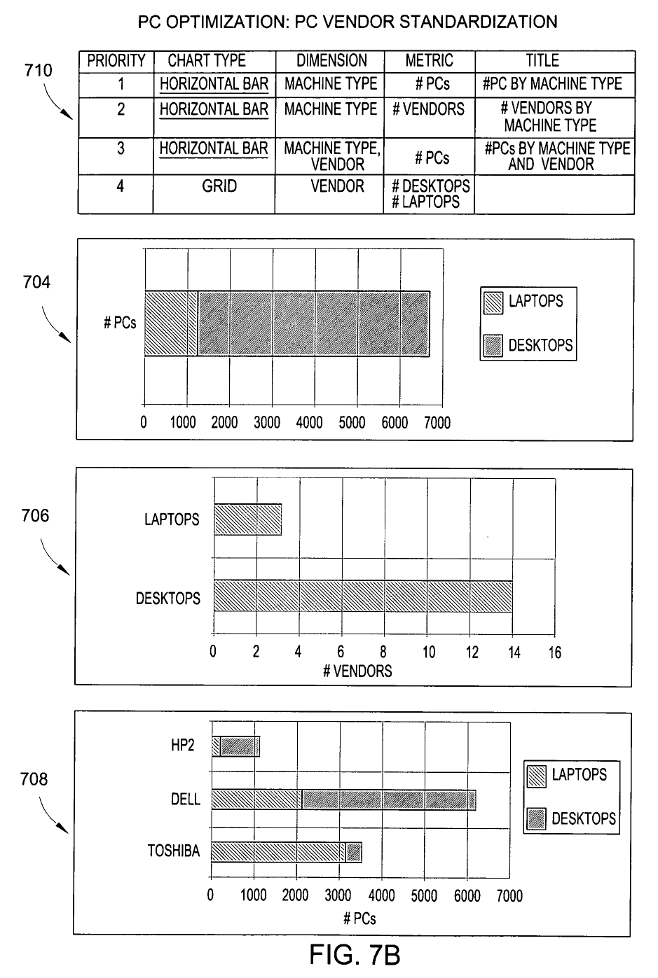

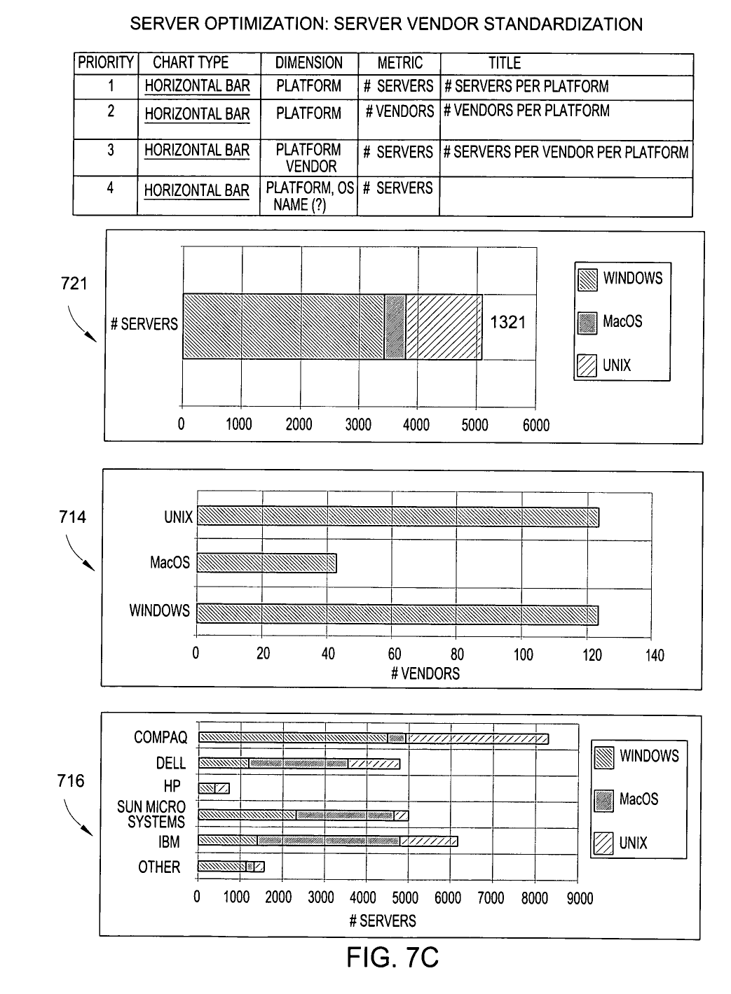

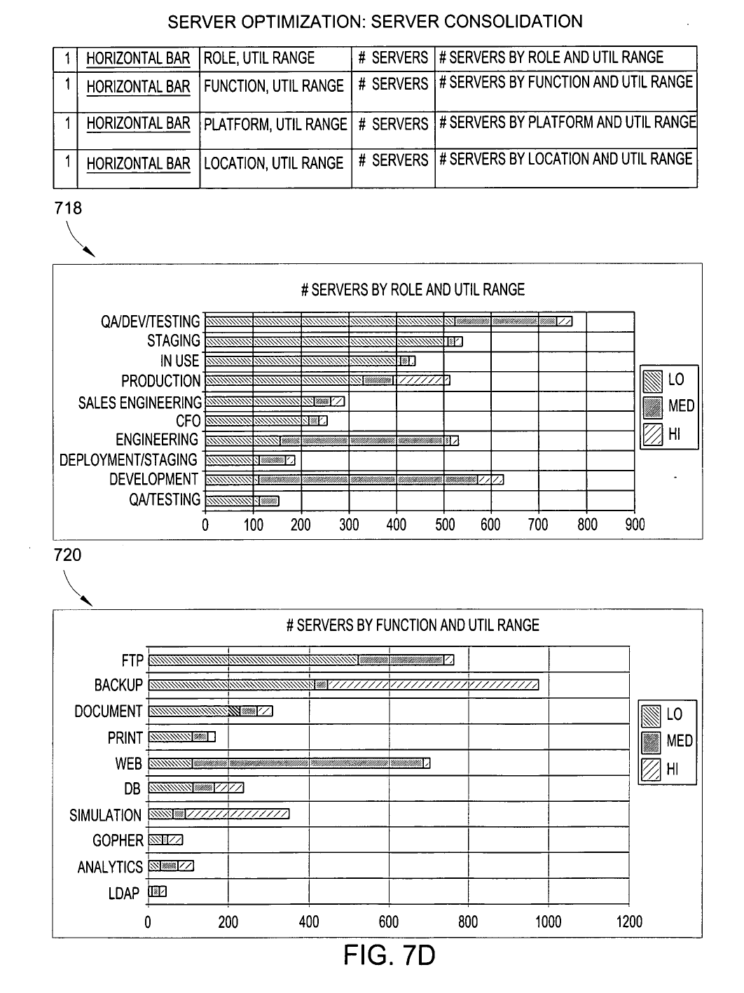

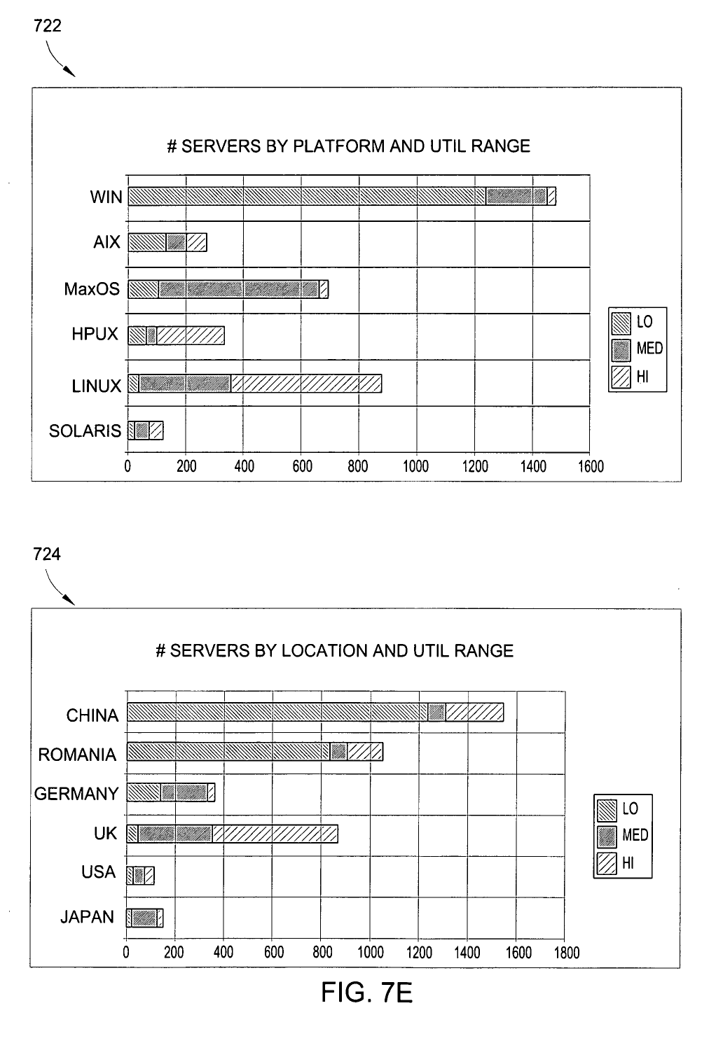

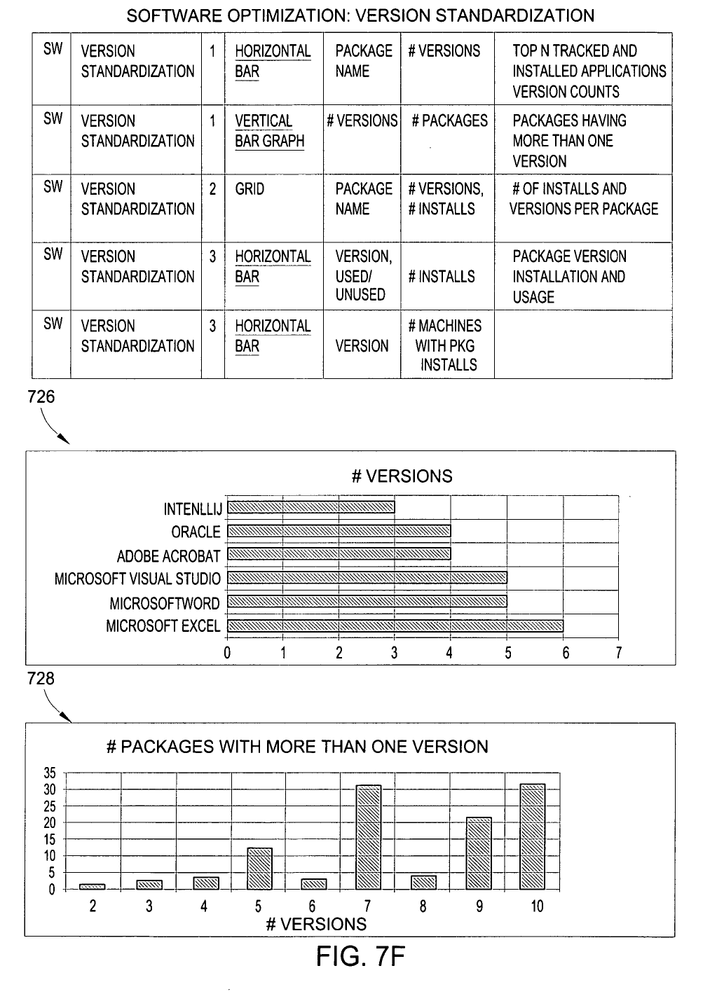

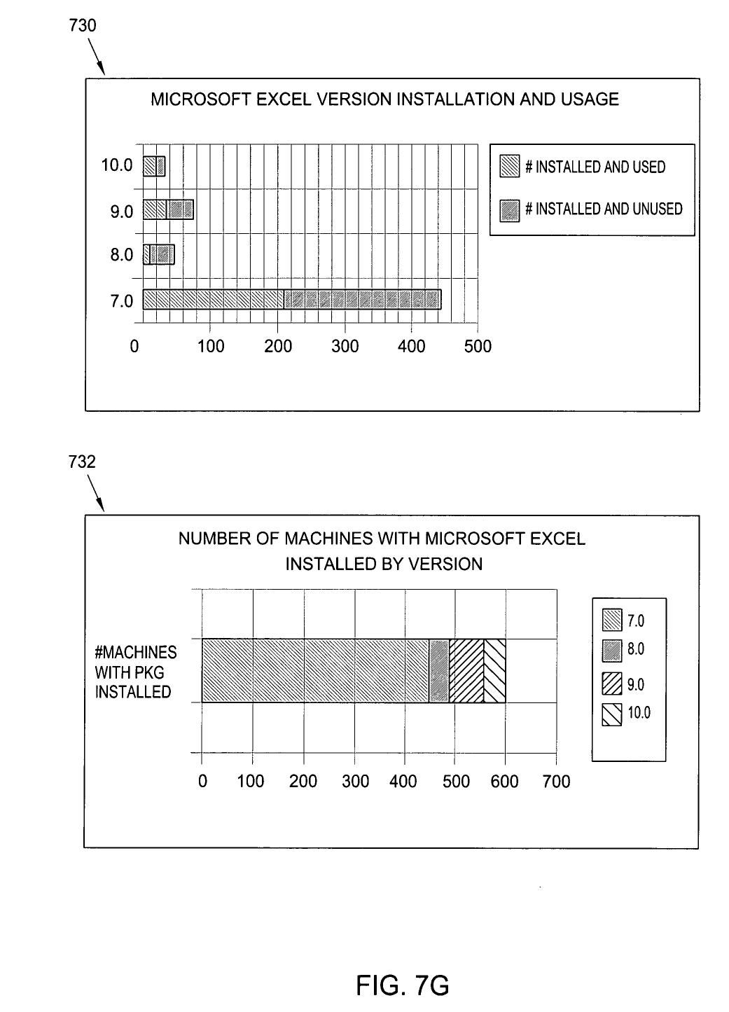

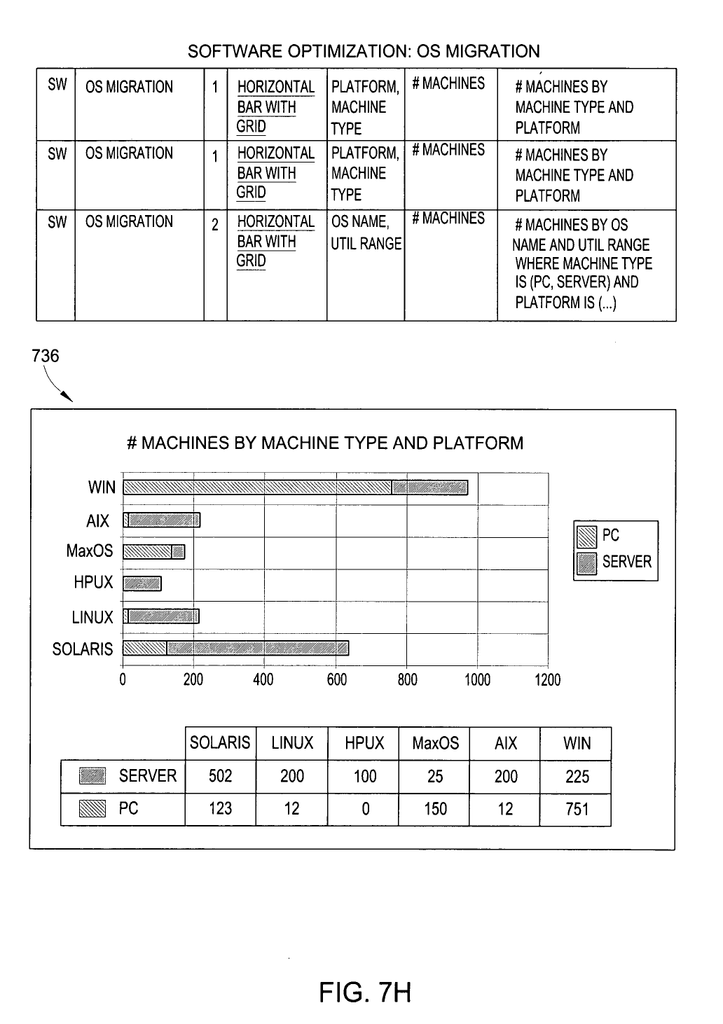

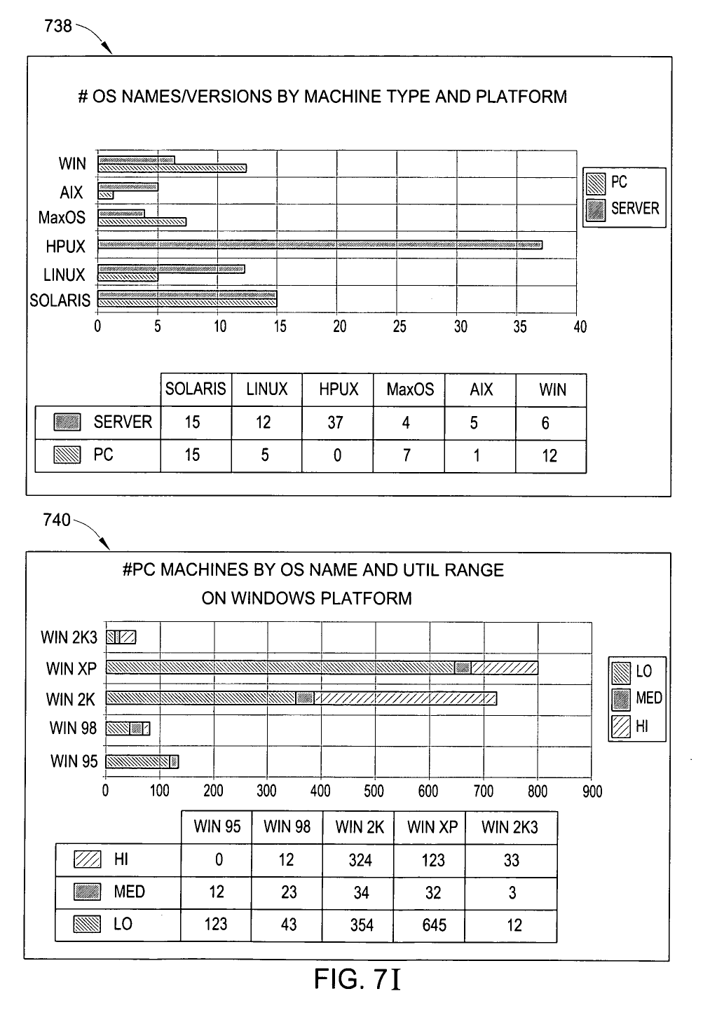

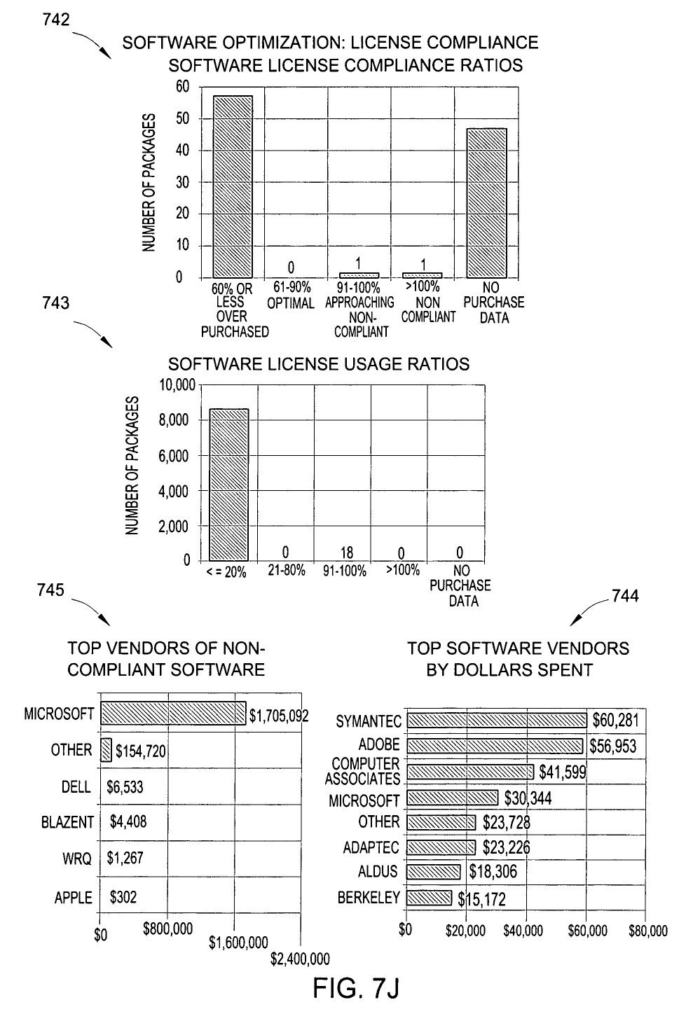

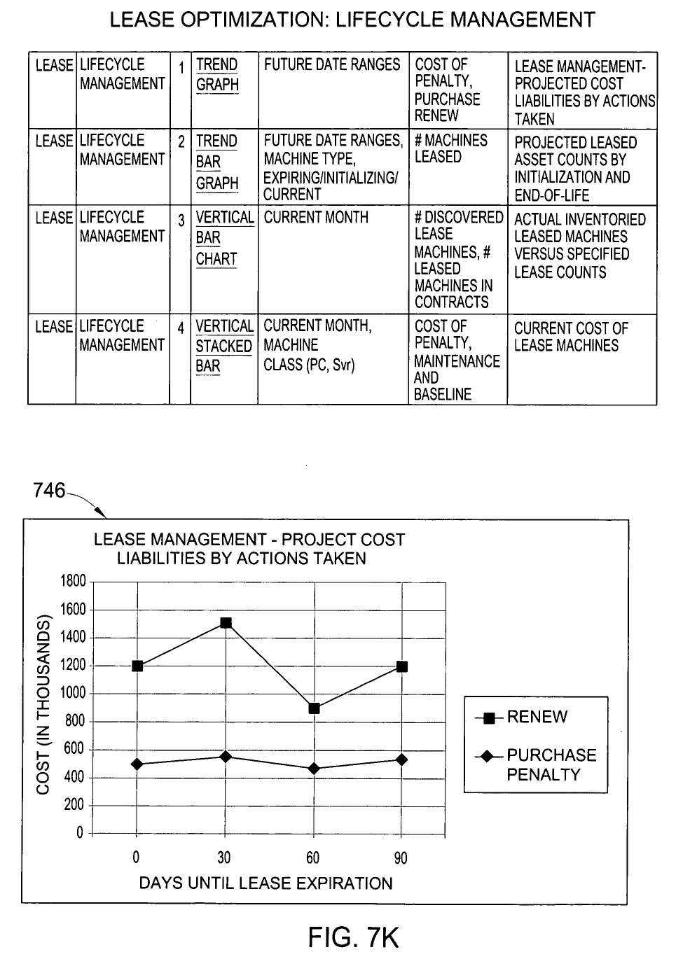

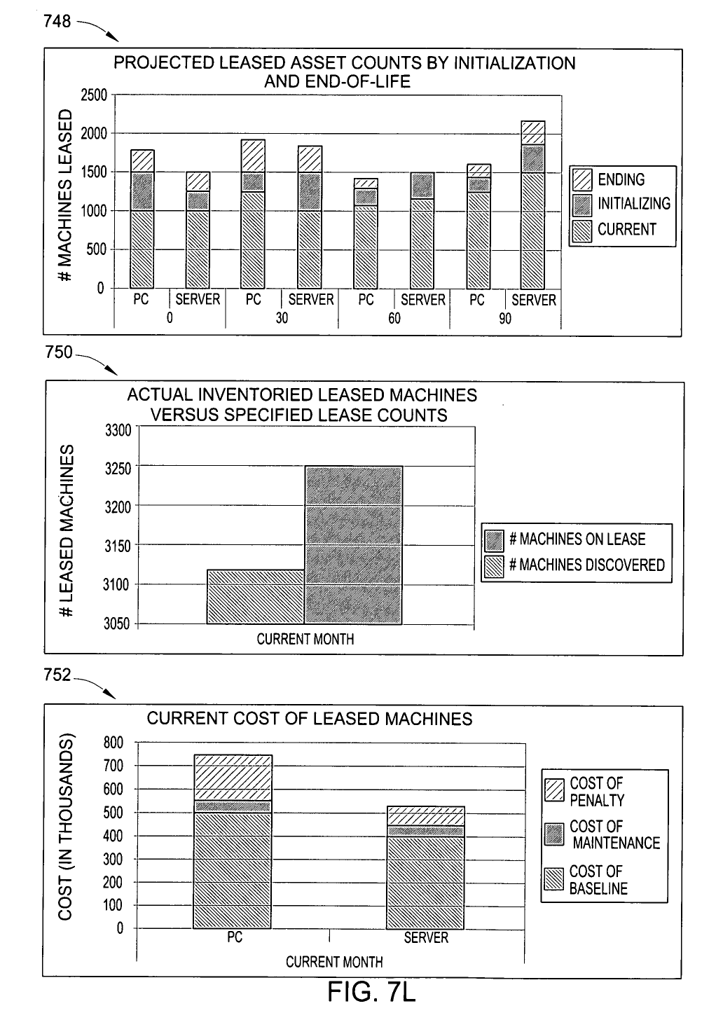

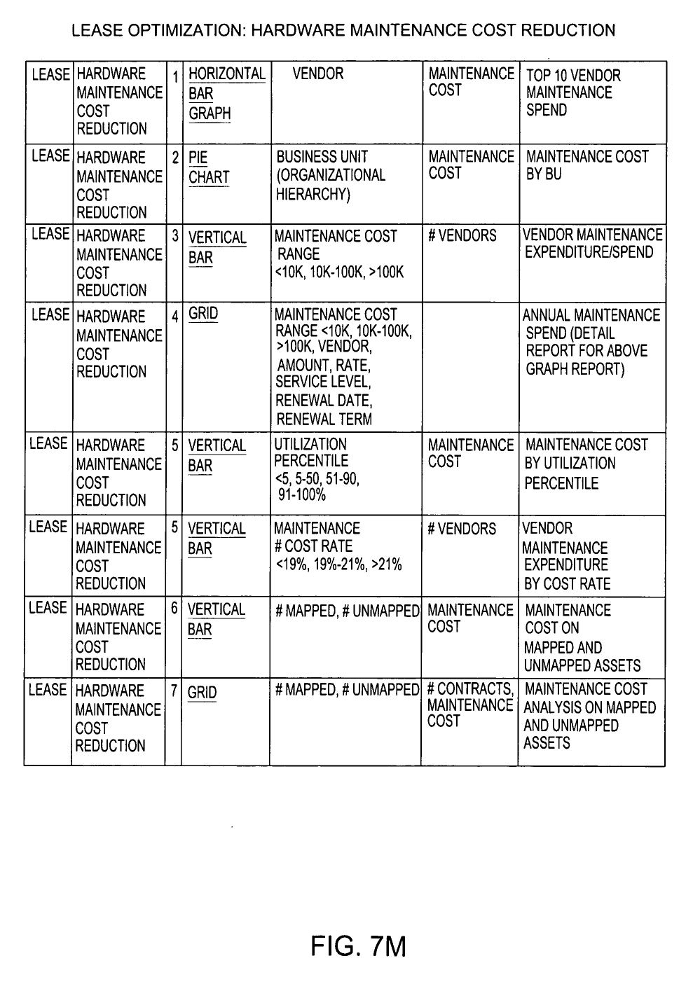

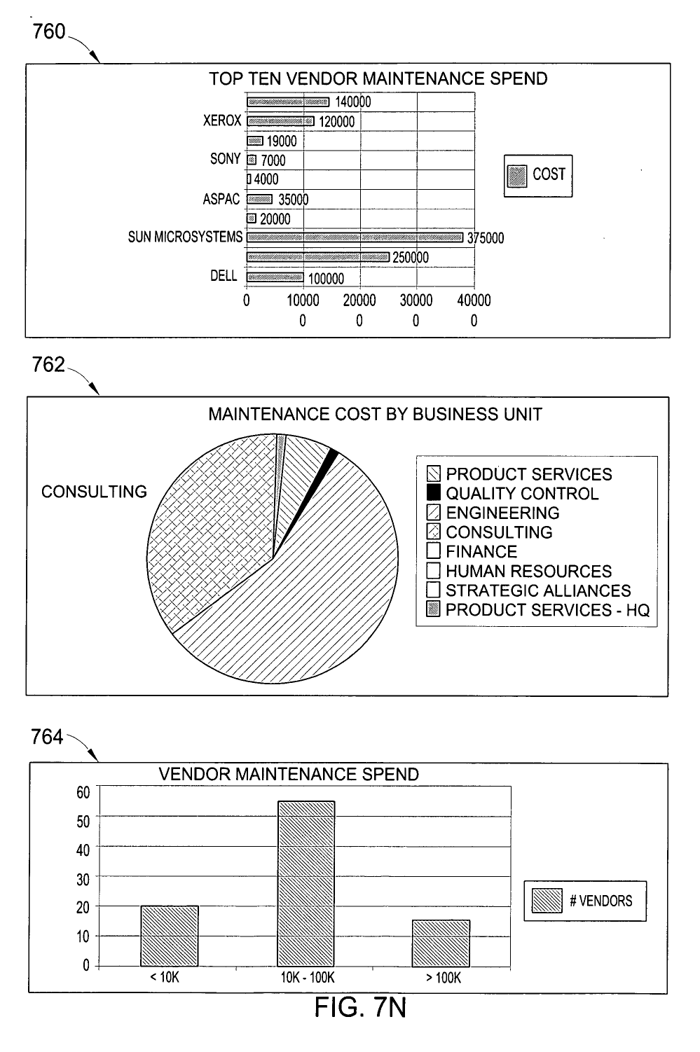

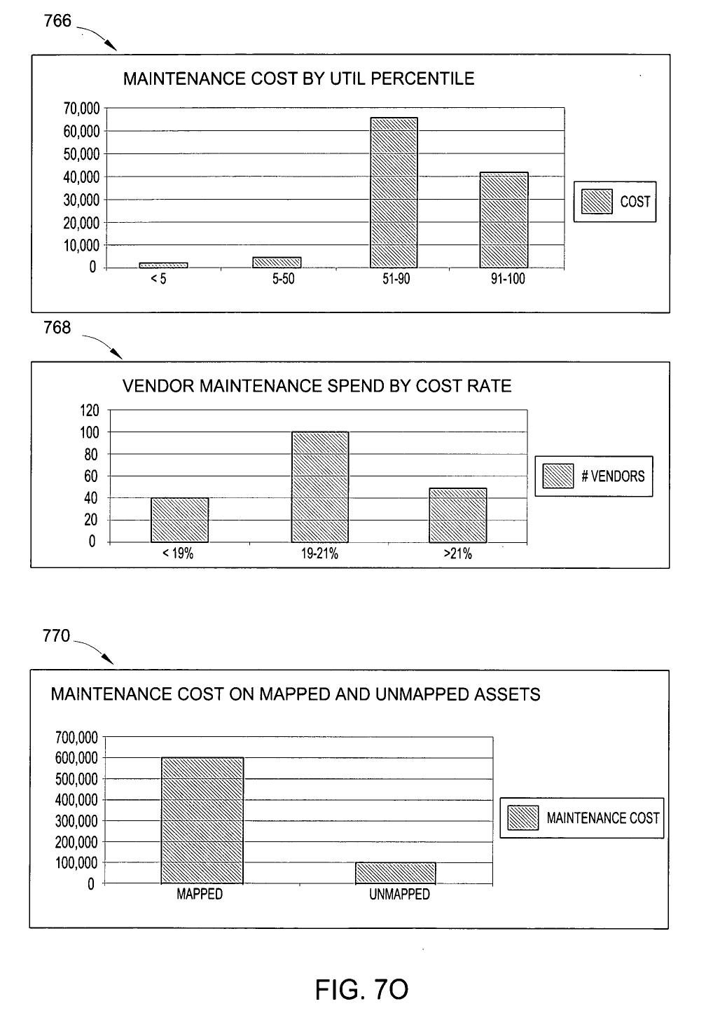

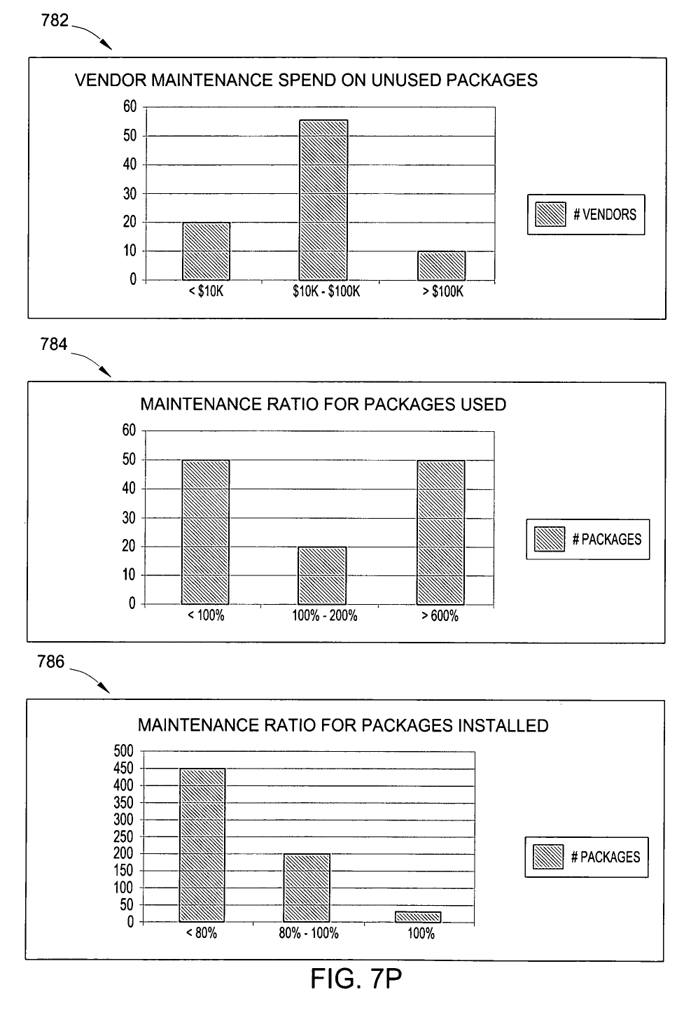

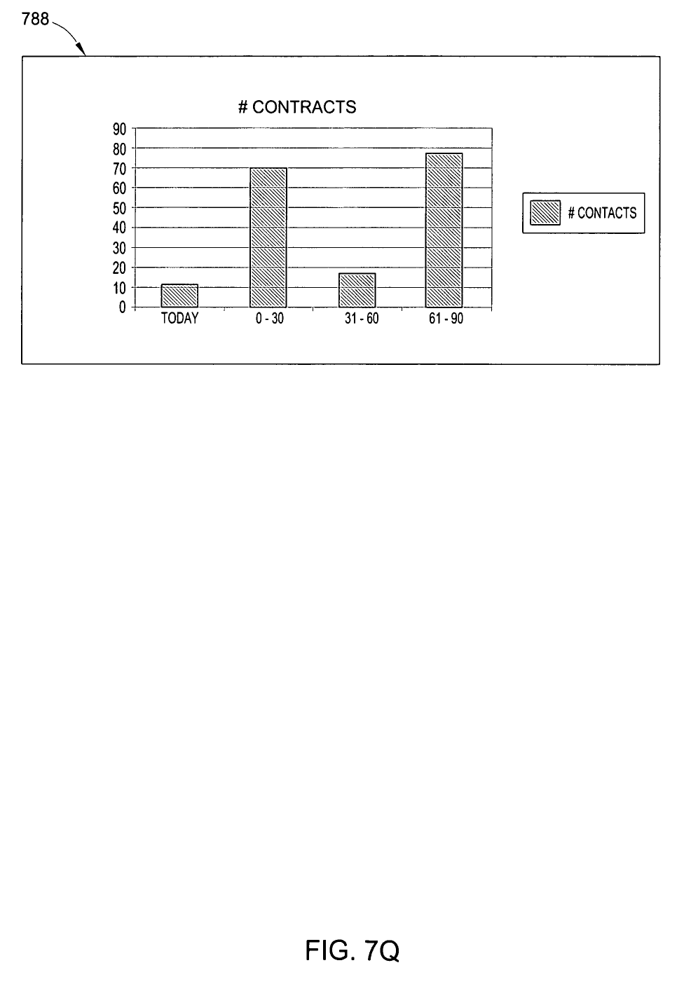

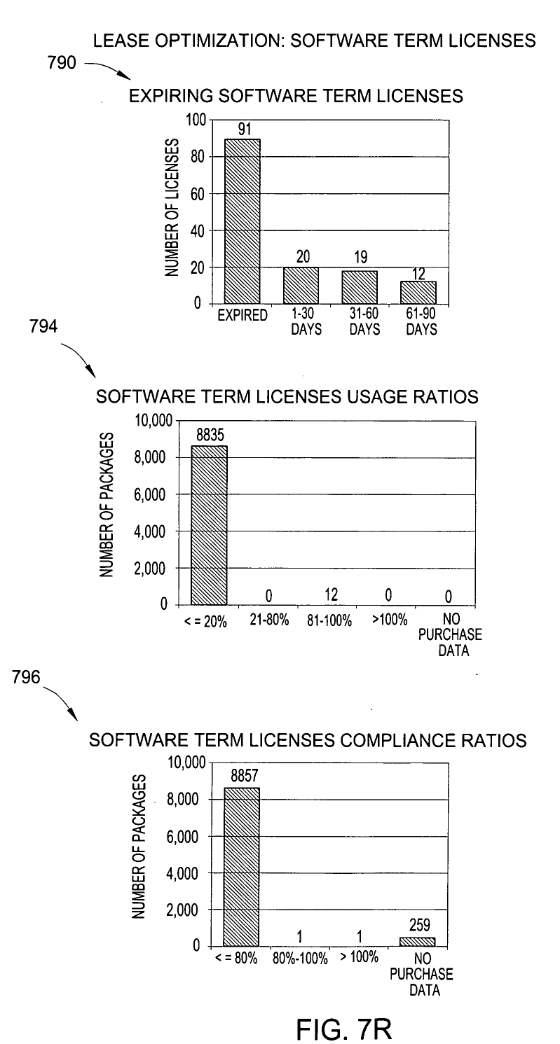

As described above with respect to FIGS. 1-5, embodiments of the present invention may be implemented through systems herein described and the aforementioned reports may be generated and displayed for the viewer or user on an exemplary display device such as a computer monitor. FIGS. 6A-6M depict example GUI screen displays of reports generated in accordance with those and other embodiments of the present invention. FIGS. 7A-7R, described herein, depict analytics and scenario overviews of selected IT asset information used to populate certain of the reports depicted in FIGS. 6A-6M in accordance with embodiments of the present invention.

Specifically, FIG. 6A shows an example log-in page 600 in accordance with an embodiment of the present invention. In this example, the system is password protected and customized by the person identified, i.e., Jane Smith. In this way, if the current user/viewer had previously set preferences and/or results relating to business scenarios and the like, those presets will be preserved from one session to the next. The log-in page 600 includes a user name field 601, a password field 602 and a log-in soft button 603.

FIG. 6B depicts a personalized user's (e.g., Jane Smith) home page 604. The home page includes a Monitors folder 605, a Current Workspace folder 606, a Favorite Scenarios folder 607, a Recent Analytics folder 608 and a Favorite Analytics folder 609. The Monitors folder 605 is a top level or “dashboard” view of certain critical indicators that a particular active user may be tracking. In this example, Ms. Smith is tracking her software compliance status and utilization status. The items to the right-most portion of the software compliance status bar represent out of compliance IT assets (i.e., “problems” 302 of FIG. 3). The items to the left-most portion of the software compliance status bar represent IT assets that may need attention at some point in the near future (i.e., “opportunities” 304 of FIG. 3). These items to the left-most portion of the bar may alternatively represent a different kind of “problem” that may not be as critical as the “problems” to the right, but perhaps something to which attention should be paid eventually. The two bars in the Monitors folder 605 are tracking two separate but connected embodiments of IT asset information: 1) Software License Compliance Status—Are the company's licenses out of compliance (at one end) and is the company not using the licenses very much (at the other end)?; and 2) Software Utilization Status—Is the company using all the software or is there some software hardly being used for which the company is paying?

The Current Workspace folder 606 is a list of links to summary reports the present user had previously established. For example, “Oracle true up Q204” is a project or an initiative underway in the company. The four items listed under the project are previously run and saved custom reports, which are all related to the “Oracle true up Q204” project. The other two items listed in the Current Workspace folder 606 are two other types of projects or initiatives underway and the kinds of views the current user might like to have to show how the projects are progressing.

Thus, advantageously the Current Workspace folder 606 displays a clustering or organization the user has created as opposed to something created in anticipation of a business problem. In the “Oracle true up Q204” group, for example, the user ran those reports in the course of running a scenario—which comprises a series of reports focused on a particular business problem—or some investigation. The user then saved it into the folder called “Oracle true up Q204” because those are all the contracts related to the Oracle project. Alternatively, in the case of, for example, a senior manager, his/her analyst may have run the reports and populated the whole work space as a short cut for the senior person.

The Favorite Scenarios folder 607 lists the user's most current scenarios from a page that lists all the scenarios available. The Favorite (or Standard) Analytics folder 609, which does not show any items listed in FIG. 6B, would include stand-alone reports focused on some condition, i.e., accounting computers or accounting software packages. The Recent Analytics folder 608 is a history list of reports the user recently ran.

Thus, FIG. 6B highlights an advantage of embodiments of the present invention in that when a person logs in, substantially everything current is on one screen page and the user can pick up where she left off. A majority of the time, the user does not need to go to any other page because she is following up on an ongoing project and the information needed is on one page. This allows the user to continue with her analysis from inquiry to inquiry, without the need to rerun all previous scenarios that got her to this point.

FIG. 6C depicts a user's My Workspace page 610, which is an expanded version of the Current Workspace folder 606, shown in FIG. 6B. At this page 610, the user manages and creates the items that appear in the Current Workspace folder 606. To assist in creating those items, the My Workspace page 610 includes command buttons Add Folder 611, Rename Folder 612 and Delete Folder 613. This page 610 may also include a longer list or archive of previous items the user does not want to include on the home page 604 but information researched earlier, which may come around again and is important enough to include on My Workspace page 610.

FIG. 6D depicts the Analytics Library page 615, which includes a comprehensive listing 616 of substantially every report accessible to the user. Each item on the list includes pertinent and related information. For example, substantially everything related to PC Inventory Analysis is included in a dynamic detail display 617. The list can be indexed in different ways, for example, by subject, by alphabetic list of report titles or by report type. The Analytics Library page 615 also includes a Scenario Analytics folder 618, which displays reports tied to scenarios and clustered separately, and a Custom Analytics folder 619, which includes the results of running a report and customizing the view. This is useful when a user needs a particular sort. By simplified the view, the user may want to save that simplified version because it highlights a particular insight for which the user is looking. In this example, the user saves the customized view under a meaningful name so it can easily be recalled later.

FIG. 6E depicts an Administration page 620. This page is preferably accessible if the user has administrator authorization at log-in or if an IT administrator needs to perform administrative tasks. The page 620 includes three folders. The first folder is entitled Tools 621, the second is entitled Reports 622 and the third is entitled Server Status 623. The Tools folder 621 includes various administration tools used to manage the IT asset data in the system. For example, the Catalog Manager item keeps track of the company's software and how it is mapped to different places. The User Management item keeps track of the user names and privileges of the organization. The listed items are stand-alone modules that launch and run separately to administer the IT asset data in the data warehouse 220 (FIG. 2). The Reports folder 622 is a list of diagnostic and data validation reports re-run to make sure the system is deployed and working correctly. The Server Status folder 623 checks the status of the system's host server 106 (see FIG. 1) or host server 206 (see FIG. 2)

FIG. 6F depicts the Scenarios Analytics page 625, which shows each scenario as a set of reports focused on a business problem or issue. The reports are clustered into solutions, such as the Software Optimization solution 626, the PC Optimization solution 627 and Server Optimization solution 628. For example, the Software Optimization solution 626 is the general solution area where several different scenarios are focused on a very specific problem. These various scenarios are explained in further detail in FIGS. 7A-7R herein.

The Software Version Standardization 629 is one scenario shown in a dynamic detail display. The business problem coupled to this scenario relates to software. Specifically, the company may be running earlier versions of software on certain computers. These computers may not have upgraded to a current version. If it is OS software, the company would like to make sure every computer is running on the same version. The IT related business problem may include how the company knows which computers are behind and which are running the new version. There are a series of reports that prompt a search of the data warehouse for these answers.

First, the search seeks which version of software is running on which system. Then, the analytics are organized together to identify the information that has been retrieved. The analytics look at which software packages include multiple versions and which are the worst offenders. For example, if one system is running five or six versions, that system is a candidate for aligning onto a single version. This migration will take some work. Therefore, one needs to focus on which situation is business critical. Thus, FIG. 6F shows the high level reports that help the user identify the worst offenders. Then, once the user looks at those IT assets, the user can isolate them and decide which one(s) to address first. Then, the user can navigate to a specific list of IT assets that have the problem software. When the information is analyzed, each of these scenarios leads to a specific analytic view, for example, a multi-column report showing the software package name, the category of the package, the vendor and version.

FIG. 6G depicts an example Scenario Overview page 630 for the Software Version Standardization scenario discussed above. This page 630 is a graphical overview of the situation. The graph 631 shows the “Top Ten Tracked Packages With Multiple Versions Installed”. For example, MICROSOFT FRONTPAGE and NORTON ANTIVIRUS each have six versions on the given network. Those would be candidates targeted for standardizing onto a single version. Alternatively, the user may look at something else more critical that everyone is using, e.g., OUTLOOK or EXCEL. Even though there may be only three versions, because everyone is using these programs all the time, a business decision may need to be made.

Thus, embodiments of the present invention provide the user with the IT asset information needed to decide, depending upon that user's situation at that time, which one(s) of these packages is(are) more critical for them. Alternatively, there may be multiple graphs showing, for example, multiple versions by department or multiple versions by job title.

The highlighting oval 632 surrounding one of the listed software packages—in this example NORTON ANTIVIRUS—indicates that the user is choosing to view more details. So she selects that item. FIG. 6H depicts a page 635, detailing an analysis of the item chosen in the oval 632 of FIG. 6G. In this particular example, the user had identified the NORTON ANTIVIRUS software as a critical issue. So, she would like to focus using an analysis grid 636, which shows how the NORTON ANTIVIRUS software is deployed by version.

In this example, there are 5 versions installed. The user can view how many computers are installed with this software, on which computers they are being used, and on which ones they are not being used. This helps the user determine the problem and will help the user determine how much work it will take to get everybody on the latest version. The view column shows additional columns that could be in the report. If the user chooses the “Department” view, as depicted, a new page will be displayed.

FIG. 6I depicts that new page 640 detailing “Departments”. As shown, a column named “Department” appears in the report. The user can readily see which departments have NORTON ANTIVIRUS software. Within the “Department” view, the user can sort by version. This could manifest the problem as being in one particular office or one particular region and perhaps it would be a simple upgrade exercise. Although all the fields are not populated in the pages discussed herein, it is to be understood that those fields can include pertinent information in like kind with the fields in the same columns. Here, the user has chosen the Finance department, which is detailed on the next page 650 of FIG. 6J.

FIG. 6J depicts the page 650 showing the geographical locations of the Finance department. In this example, the user has chosen New York. Now the user can decide, if there is an IT department person in New York, she can alert that person, for example, by sending an e-mail, and explain what is happening in the New York Finance Department and ask that it be resolved.

FIG. 6K depicts a page 660 showing a list of all versions being run on computers in the New York Finance department. If a user wants to look at a particular version in the Finance department in New York, she clicks on that one. Here, she has chosen version 4.0.1.94, which takes the user to the next page (FIG. 6L). This choice is depicted by the highlighted oval 662. Again, it is to be understood that the remaining fields would be populated with information but have been left blank for simplicity purposes.

Until now, all that has been presented are aggregate counts of computers or other IT assets. This is a helpful advantage when dealing with enterprise systems because with relatively large networks, a user may have started with a list of 10,000 or so IT assets. As such, during the guided analysis phase, the system shows an aggregate of IT assets. One goal is to find those buckets or pockets of IT assets (e.g., computers) of interest. Once the user isolates the ones of interest, the system displays the actual list of units. In this regard, FIG. 6L depicts a page 670 including a Filter (Analytic) Context box 672 and a list of actual computers 673 with detail so a user can identify the actual computer(s) of interest plus the OS platform and computer serial number of interest.

It can be understood by viewing the Filter Context box 672 that as the user makes narrowing choices, each subfield is logged and displayed. The running list includes filters that have been applied to the whole data and the path the user took to get there.

FIG. 6M depicts an exemplary page 680 for saving the report. After the user enters her name, i.e., Jane Smith, the report is placed on her list of saved reports. Either the user can save the report using the save button 682 in My Workspace, which means only she can access and review it, or in the Analytics Library Custom Reports (a.k.a. Shared Workspace), which can be viewed by others. Alternatively, the user can cancel the session using the cancel button 684. The user can also write her description about the report in the description box 686. This page will save the previous “Detail” page.

If the user desires to save additional reports, for example, to view what is happening in all of the departments, the user will save the Analytic View. In this type of scenario, the user might have saved two or three different views in the course of performing an guided analysis. Then, the user can return and see the snapshots of this process she has been going through. This advantageously enables the user to return later and perform the same search again or allow someone else to run these series of reports, without having to go through the whole process of sorting and adding columns.

FIGS. 7A-7R depict various scenario overview graphs generated to populate a portion of the page 630 shown in FIG. 6G. By way of example, when a user enters a scenario, she may see several graphs, where the number of graphs depends upon which scenario is run. Each set of graphs is defined by each scenario.

Specifically, FIG. 7A depicts an overview graph 700 of the software version standardization scenario similar to the graph shown in FIG. 6G. Here, a higher level aggregation is depicted. It does not describe which packages have which version. Rather, this graph assists the user with understanding the entire landscape of how many computers have large number of versions. The example shows many computers that have two versions 701, which should not be a major problem. Then, there is a small number with five or more versions 702. The user might want to address this issue. The graph 700 then focuses on a “problem” condition. In this particular example, the user/viewer must decide whether five or more versions are going to be a problem condition.

Alternatively, the system may make an automatic judgment or present a suggested problem to the user. For example, the system may analyze a second related condition and find that it is in compliance. Or, the user may be prompted with text that says “if over 100 percent, the company is non-compliant”. If this is five or more, the text might read “needs standardization,” or the like. Alternative commands and text may be included and is contemplated by embodiments of the present invention.

FIG. 7B depicts three sample graphs 704, 706 and 708, relating to a PC Vendor Standardization scenario. In this example, a number of vendors of PC's, i.e., DELL, HP and TOSHIBA, have been previously purchased. This may be because of different policies or for economic reasons at the time of purchase. There may also have been a merger situation. The business issue relates to moving every PC to the same vendor while maintaining inventory.

The top table 710 identifies the top three items and the three graphs 704, 706, and 708. So, the top entry “PC's by Machine Type” is the title of the first graph 704, Vendors by Machine Type is the title of the second graph 706 and “PCs by Machine Type and Vendor” is the third graph 708.

Turning to the first graph 704, the bar shows selected IT asset information regarding how many desktops and laptops are on a network. It may often be the case that a desktop vendor may be sufficient for desktops but not sufficient for laptops. This may be the reason for the disparity between the two.

The second graph 706 shows selected IT asset information relating to the number of vendors for laptops verses desktops; i.e., the number of vendors or the diversity of vendors on the network. Here, there are fourteen different desktop computer vendors, which may be considered a large diversity. It may not be know whether this is a problem to the current user's organization.

In the scenario sequences previously discussed, each graph is an entry point into a grid report, described herein as a table (see table 636 in FIG. 6H). The table works through the details. Each of the graphs 704, 706 and 708 are basically a different entry point where the user may enter an associated analysis grid. For example, if a user sees fourteen desktops and wants to know more detail about them, the user can select the desktops. Then, the user would see the desktops, the department, what city the desktops are in, what platform the desktops are running, the machine manufacturer(s), and the like.

In graph 708, the user can observe various utilization metrics for the computer(s). This is where the user can observe many different manufacturers and many laptops and desktops. As best shown in graph 708, the majority of the fourteen vendors comprise DELL's and TOSHIBA's. Thus, the graph 708 depicts data at the platform level and PC's by vendors. In this example, there are 200 HP's laptops and 999 desktops, 2132 DELL laptops, 4324 DELL desktops, 3345 TOSHIBA laptops and 343 desktops.

Using this information, a user can observe that the company does not own many TOSHIBA desktops. The user can decide to remove other brand desktops and make them all DELL's. The user might want to remove the HP laptops. The user may enter the analysis grid and actually see how those break out. Then, the user might determine that all of those HP laptops are used by sales people at a certain place and prefer them for some reason. This gives the user the ability to begin understanding more of the overall IT asset story. Thus, every graph gives the user a clue as to which vector she wants to follow and look for a problem. It does not give the user the immediate answer, rather, a way to highlight the important targets where the user is looking to standardize. This provides for a very flexible and useful system where the user is able to follow different paths depending upon the choices she makes along the way.

In another business problem/issue example, the user may have an upcoming contract negotiation with DELL. The user looks at the third graph 708 to see if she can standardize more systems using DELL. Because the user has a larger volume of DELL's, she may be able to obtain a better deal. Perhaps, the user will change all HP desktops to DELL and phase out the HP's.

FIG. 7C depicts graphs relating to the Server Vendor Standardization scenario. The graphs 712, 714 and 716 relate to the platform landscape or main operating systems, i.e., WINDOWS, SOLARIS, UNIX or MAC OS. Graph 712 represents the platform landscape and how many of each the company supports. Each graph is a starting point for doing an analysis. The user may focus on all WINDOWS computers and analyze further into the analysis grid. Here, the user would already have the first filter on the grid.

The second graph 714 provides the user with IT asset information from another perspective. This graph shows how many vendors exist per platform. The user may first decide about standardizing within a certain platform before standardizing across platforms as shown in the earlier graph.

The third graph 716 depicts the number of “Servers per Vendor per Platform” information. Here, the system is putting the two previous dimensions together. Thus, this graph shows the landscape and can be used to form a plan on consolidating a vendor. The general idea would be to consolidate the business with the given vendor on the one hand and to simplify IT maintenance planning on the other hand. Again, it is important to note that all of this information is at the user's fingertips so she can make an informed decision.

One role of this type of graph is to display a high level landscape view. The user can then decide if she wants to consolidate the relationships with vendors. She knows she can check back and start pre-planning, getting people working on buying new computers and retiring old computers. Weeks or months later, the user can run this same graph again and see how the bars have changed. This provides a way to monitor the progress.

In one embodiment, the user can run a report as discussed above and save it as a snapshot. Then, a month later, she can run it again and if she does not remember, she can review the earlier version and look at a new one and see what has changed. This captures history and puts it together to see the trend. Alternatively, the user can perform road mapping to see where she was last month verses this month.

A Server Rationalization scenario in accordance with embodiments of the present application is also provided, which is a compliment to the other server reports. The user may use the Server Rationalization scenario when looking at the whole server population, e.g., looking at vendors, consolidating software, and so on. The user may be surveying and looking for problems depending on the kind of issue at hand. The user may want to know what is happening with a particular server or a particular set of servers. The user is not attempting to find servers with problems or IT-related business issues. The user knows something is happening with a particular server or wants to move the server along.

Thus, in the Server Rationalization scenario, the user is attempting to understand what a computer or set of computers are doing. This can start with a prompt where the user requests a page of all the servers in a particular location or all the database servers. Alternatively, the user can put in a particular server name. The user can be prompted to search for a particular set of servers. Once she finds them, she can look at them in the same analysis grid.

FIGS. 7D and 7E depict a Server Consolidation scenario overview. This scenario may be helpful, for example, if the user is aware of all of the servers on a given network. Then, if a new business initiative is created and there is a need for three new servers, the user can conduct a review of existing servers and their usage. The graphs 718, 720, 722 and 724 give the user the ability to see where she has a few servers not working to full capacity. They can be consolidated to provide some capability. The graphs show three different facets of the server population.

The first graph 718 shows the number of servers by role and utilization range. That is, this graph shows all the servers and the different roles they are playing in an enterprise. The user may be looking for the ones with low utilization. If the user finds two low utilized servers in the same role, then she can consolidate them into one and free up the other server. The graph 720 shows the number of servers by function and utilization range. The graph 722 shows the number of servers by platforms and utilization range. Generally, when consolidating servers, the user will first look at platform and then function.

The graph 724 shows the number of servers by location and utilization range. The user might just start by location so each one of these practically offers a different way to look at the last graph 724 by location. These graphs allow the user to look at the landscape where IT assets are concentrated. Now, once the user enters the analysis grid and sees different dimensions for each of the servers, the user will see its role and function, department and location. Thus, the charts give the user a way, instead of looking at a list of two thousand servers, to focus down to a few hundred items. At a glance, or pictorially, the user can get some ideas for starting and then each one of these gives a way to make the first cut, which puts the first filter on what she wants to do.

Alternatively, the user can survey all the graphs but does not have to make any decisions. Instead, the user can see some of the detail and then decide what to do. For example, the user could go into the analysis grid and sort by location. She can then compare locations on the page and observe opportunities she had not considered before. Thus, the graphs serve a dual role. They give a picture of a landscape related to a business problem and they provide specific entry points into the analysis.

FIGS. 7F to 7G depict a Software Standardization: Version Standardization scenario. The first graph 726 shows a number of versions of software packages. The second graph 728 shows a number of software packages with more than one version. The third graph 730 details the MICROSOFT EXCEL Version Installation and Usage from the previous graph.

Referring to graph 726, in this particular example, there are six versions of MICROSOFT EXCEL in the network. With reference to graph 730, the user looks at the version installation usage, which compares version 10. Version 7 is split between computers being used and ones not being used. The ones being installed and unused are an easy target to remove.

The user may want to determine why people are still using version 7. Understanding usage is a large part of the picture in deciding what kind of action to take. These are all entry points into the guided analysis. Once the user sees the landscape of what is being used, she can get into the guided analysis and find out who is actually using version 7 and what is happening with it.

FIGS. 7H to 7I depict a Software Optimization: OS Migration scenario. Here, like the version standardization scenario, the general business problem relates to the organization having a lot of WINDOW-based computers—some are WINDOWS 98 and some are WINDOWS 2000. As an example, the user has many WINDOWS versions and she wants to standardize to one particular version. Another example is that the user has a number of computers by computer type and platform. The graph 736 shows a number of different platforms. Perhaps the user wants more or less UNIX computers, the user may want to consolidate everything on LINUX. The user may want to survey the operating system landscape and platforms.

In the next graph 738, the user can look at PCs and servers to see how many of each platform. Whereas Graph 736 shows the number of machines by machine type of platform, graph 738 shows number of OS names/versions by machine type and platform. So graph 736 is telling the user how many machines available with a certain platform and graph 738 is, given the platform, how many versions are available in each.

The third graph 740 provides the user a sense of how far the target is out of step. The graph shows the utilization of the computers. The user may want to focus on the ones being used a lot, although the ones not being used would be candidates for removal. There may be some reason they cannot be upgraded.

FIG. 7J depicts a Software Optimization: License Compliance scenario similar to the one previously described. The graph 742 shows the license installation ratio. For example, the ratio of non-compliant software packages is shown toward the right and the ratio of under-installed, i.e., over-purchased, is shown on the left.

The second graph 743 relates to software license usage ratios. It discloses the ratio of the number of software packages legally purchased to the number used. Here, a low number would be a “problem.” If one purchased 1000 packages and is only using 275, it is an indication to do something. The user can either find a way to give back licenses or find out why people are not using them. That is a “problem” condition. If the license usage is 100 percent, that is a good condition. That means people are using everything purchased. The packages not being used yields a savings. It may take the company back into compliance.

Comparing the installed to the purchased ratio, the user could de-install all software packages over-installed and the company would not miss them. Alternatively, the graphs can display the ratio of the installed value over the purchased value. For example, if the installed is 1200 but the purchased is 1000, the company would be out of compliance by 20 percent. This ratio is called the “compliance ratio” or “the license installation ratio.”

Expressing ratios is an important advantage of embodiments of the present invention because the actual numbers may change. This way the company could put those packages over 100 percent into compliance.

A third graph 744 depicts the license compliance and is called the Top Vendors by Dollars Spent. This graph focuses on the vendors where the company is spending the most money. Looking at the sample graph showing ADOBE, COMPUTER ASSOCIATES, MICROSOFT—this is where the exemplary company is spending the most money. So this is where the company should focus its compliance realignment.

A fourth graph 745 depicts graph Top Vendors By Cost of Non-Compliance Software. This graph manifests the problem. For example, if the company is 20 percent out of compliance, then it must multiply the 20 percent by the individual package cost.

FIGS. 7K to 7L depict a Lease Optimization: Lifecycle Management scenario. It is difficult to manage and track leases of IT assets in large enterprises. For example, in an organization with 10,000 computers, the lease contract might have been negotiated by different purchasing agents and in different places. Therefore, the leases may start at random times and extend for different terms. This may happen every quarter or even every month, depending on how the lease programs are managed.

The first graph 746 shows how certain IT assets are coming to the end of their lease. The user is left with a choice. She can hold the IT asset and renew the lease. If so, she may have to renegotiate the terms of the lease. Alternatively, she could send the IT asset back and have the leasing company send her a new IT asset. The user could also purchase the IT asset. Another option would be to do nothing and pay the penalty. There is a penalty cost for keeping the IT asset. The user can continue to make monthly payment and pay a penalty because the IT asset has not been renewed or returned. For example, if one assumes the penalty is zero at day 0, at day 30 it is $400. If the company does nothing with those IT assets, the penalty will increase to $800. It will increase another $400 in 60 days and $1600 in 90 days.

Significantly, there are three different courses of action shown in the graph 746 of FIG. 7K. Each one assumes a course of action and continues the course of action for at least the next 90 days.

The graph 748 depicts Projected Leased Asset Counts by Initialization and End-Of-Life. The bottom portion of each bar shows how many machines are current (continuing on lease). The middle portion of the bars shows how many machines just came on during a given time period. The top portion of the bars shows the IT assets going off lease. The overall height of the bars in graph 748 shows the total number of IT assets at this particular point in time. Thus, this graph provides the user with a way to start thinking about the IT assets 90 days out.

The graph 750 shows the user what IT assets are on the network. Then, that bar is compared to the number of IT assets on lease. This is a way of reconciling the count of IT assets between bookkeeping and actual. The two should be about the same amount. Otherwise, there is a discrepancy and the user needs to figure out why. The graph 752 shows the total costs the company is paying for the leased IT assets. This includes baseline costs, maintenance and penalties of leases that have expired.

FIGS. 7M-7O depict a Leased Optimization: Hardware Maintenance Cost Reduction scenario. For example, one way to reduce the cost is to reduce the different types of machines to simplify the maintenance situation. The first graph 760 shows the Top Ten Vendor Maintenance Spend data. The user will likely consolidate to vendors with whom the company is doing most of its business. The second graph 762 is the “do nothing” graph. The third graph 764 shows the amount of money spent on vendors, where exceptions are important. The fourth graph 766 depicts maintenance cost by utilization percentile. This allows the user to appreciate actual use of an IT asset, such as keyboard and mouse use. Now the user can see which machines are heavily used and which ones are not.

Graph 768 depicts vendor maintenance spend by cost rate. That is, the maintenance costs are a percentage of hardware costs. Actual percentage is negotiated at the time of the maintenance contract. This graph allows the user to look at cases with high percentage of maintenance costs and try to move them out of that bucket. The last graph 770 depicts maintenance cost on mapped and unmapped assets. Here, if a lot of costs are on unmapped assets, it is desirable to move them to mapped assets so the company can track them.

FIGS. 7P to 7Q depict a Lease Optimization: Software Maintenance Management scenario. The analysis here is similar to the software license compliance scenario discuss herein.

The graph 782 depicts vendor maintenance spent on unused packages. The intention is to move IT assets from the middle bar to the left bar. This graph focuses on high value targets.

The graph 784 depicts maintenance ratio for packages used. This may include the number of contracts/number of packages being used. A 600% value means the company bought 6 times more maintenance contracts than it is actually using. Thus, 100% is a non-problem condition in this given case. Using the ratio method, the company would have ⅙ the amount of machines for which there are maintenance contracts.

The graph 786 depicts maintenance ratio for packages installed. The ratio may be contracts purchased to install/maintenance contracts purchased to use. This allows the user to see that the company may have purchased more than it is using or less than it actually needs. Both are problem conditions. Instead of looking at actual numbers or dollars involved, it is desirable to look at the ratio. The graph 788 depicts the number of contracts at certain time intervals. This graph assists the user in when to renegotiate a deal for maintenance contract.

FIG. 7R depicts a Leased Optimization: Software Term Licenses scenario. The description here is very similar to that described with respect to FIG. 7J. The first graph 790 depicts expiring term licenses. This provides the user with a way to look ahead in a timeline to see how many contracts will have to be negotiated at any given time. The second graph 794 depicts software term license usage ratios showing information similar to graph 743 of FIG. J. Graph 796 depicts compliance ratios showing information similar to graph 745 of FIG. J.

One of many advantages realized from embodiments of the present invention is that the method and system herein described focuses on a business issue and puts IT asset intelligence in a business context. The method and system integrate inventory with utilization and business factors. This allows the viewer to maintain context when requesting IT asset information from view to view and across view types. Through these features, the user is able to recognize organizational information flow. This gives insight into hierarchical (review process) and discontinuous (break point) aspects.

Thus, embodiments of the present invention are not merely a series of graphs and reports that one has to navigate, one by one, to put together a summary of what is happening in an organization. Instead, embodiments of the method and system allow the viewer to follow the path of business scenario, whereby one can determine the problem and where one has possible solutions. That user can choose his or her own story to pick the dimensions he or she wants to navigate through. When a choice is made, the context of the problem goes all the way through. It enables one to focus and continue with the thread of the issue at hand. The path one takes is not dictated. Instead, the system follows the user and remembers the choices made even if the user follows a new direction.

While the foregoing is directed to embodiments of the present invention, other and further embodiments of the invention may be devised without departing from the basic scope thereof, and the scope thereof is determined by the claims that follow.

What is claimed is:

1. A computer implemented method for identifying IT assets affected by a business issue condition presented by a user, comprising:
determining an appropriate business dimension of assessment based on the business issue condition presented;
measuring the business issue condition of the IT assets as a function of the selected business dimension; and
displaying the identified IT assets results to the user such that the status of the business issue condition can be assessed by the user.

2. The computer implemented method of claim 1, further comprising generating reports of the IT asset results to the user.

3. The computer implemented method of claim 2, further comprising linking the reports of the affected IT asset results to a next business dimension of assessment pertinent to the business resolution and affected IT asset results to provide a guided analysis of the business issue.

4. A computer implemented method for visualizing an IT related business issue of a viewer, comprising:
accessing from stored memory IT asset data connected to business dimensions;
analyzing the IT asset data based upon at least one predetermined criterion;
sorting the IT asset data in accordance with the viewer's current status which relates to the predetermined criterion; and
presenting to the viewer the sorted IT asset data to assist in making an informed business decision.

5. The computer implemented method of claim 4, further comprising including the resulting initially sorted IT asset data into a guided analysis for additional requests.

6. The computer implemented method of claim 5, wherein additional requests are conducted until the viewer receives the IT asset information needed to make an informed IT related business decision.

7. The computer implemented method of claim 4, wherein the access step comprises multiple requests for IT asset information.

8. The computer implemented method of claim 4, wherein the requests range from high level IT asset information to detailed, low level IT asset information.

9. The computer implemented method of claim 4, wherein the requests are a function of the temporal status of the viewer at the time of the requests.

10. A computer implemented method for filtering, organizing and presenting a selection of IT asset information to an end user, comprising:
providing IT asset information stored in a searchable database;
receiving search criteria from an end user computer based upon a visualization of a business problem or goal and a predetermined initial scenario;
analyzing IT asset information using business specific analysis embedded in Structured Query Language (SQL) statements from the database in accordance with the search criteria;
sorting and retrieving a subset of IT asset information based upon the results of the analysis of the IT asset information; and
providing the subset of IT asset information to the end user.

11. The computer implemented method of claim 10, wherein the subset of IT asset information provided to the end user is a function of the issue presented and the business dimension(s) used to resolve the issue.

12. The computer implemented method of claim 10, wherein the subset of IT asset information provided to the end user is displayed on a display device in accordance with the requests from the user.

13. The computer implemented method of claim 10, wherein the subset of IT asset information provided includes additional IT asset information for retrieval and review by a user.

14. The computer implemented method of claim 10, wherein the IT asset information comprises server usage, upgrade needs, resource allocation and memory availability.
